(19) United States
(12) Patent Application Publication
(10) Pub. No.: US 2023/0380460 A1
(43) Pub. Date: Nov. 30, 2023

(54) COLOURING COMPOSITION FOR FOOD PRODUCTS

(71) Applicant: Givaudan SA, Vernier (CH)

(72) Inventors: Lise LAURENCON, MONTEUX (FR); Simona BIRTIC, Cavaillon (FR); Mélanie Marie-Paule Patricia HEUDRE, Vedène (FR)

(21) Appl. No.: 18/032,707

(22) PCT Filed: Oct. 22, 2021
(86) PCT No.: PCT/EP2021/079409

§ 371 Date: Apr. 19, 2023

(30) Foreign Application Priority Data
Oct. 26, 2020 (GB) 2016984.3

(51) Int. Cl. A23L 5/43; A23L 13/60; A23L 13/40; A23L 3/3472; A23B 4/20; A23L 17/00

(52) U.S. Cl. CPC A23L 5/43; A23L 13/65; A23L 13/428; A23L 3/3472; A23B 4/20; A23L 17/70

(57) ABSTRACT

The present invention relates to the use of an anthocyanin and/or betanin as a colourant in a food product, plant extracts as a source of anthocyanins and/or betanins, compositions comprising the plant extracts and processes using the anthocyanins and/or betanins or compositions described herein.

### FIELD OF THE INVENTION

The present invention relates to the use of an anthocyanin and/or betanin as a colourant in a food product, plant extracts as a source of anthocyanins and/or betanin, compositions comprising the plant extracts and processes using the anthocyanins and/or betanin or compositions described herein.

### BACKGROUND OF THE INVENTION

Nitrates and nitrites have been traditionally used as curing agents in the production of cured meat products.

The beneficial effects of the addition of nitrates and nitrites to meat products are the improvement of quality characteristics as well as the microbiological safety. The nitrates and nitrites are mainly responsible for the development of the distinct flavour, the stability of the red colour, as well as the protection against lipid oxidation in cured meat products. Nitrites show important bacteriostatic and bactericidal activity against several spoilage bacteria as well as foodborne pathogens found in meat products. According to Commission Regulation (EU) No. 1129/2011, nitrates (sodium nitrate, E251; potassium nitrate, E252) and nitrites (potassium nitrite, E249; sodium nitrite, E250) are listed as permitted food additives.

The visual appearance is of vital importance for the quality of most food products. The colour especially affects consumers when they evaluate freshness and quality of meat and meat products.

The colour of meat products is determined by a combination of different factors including moisture and fat content, but more important is the chemical form and concentration of the hemoproteins, especially that of myoglobin (Mb). Mb is affected by processing parameters including heat treatment and the use of nitrite/nitrate in meat curing is of particularly interest together with the packing method used for the product, because compounds formed by reduction of nitrite or nitrate react with Mb forming the pink-coloured pigment, nitrosylmyoglobin (MbFe(II)NO).

In products with added nitrite or nitrate the complex MbFe(II)NO is the main contributor to the characteristic colour, e.g. in dry-cured, brine-cured and cooked cured meat products.

Cured meats and meat products without nitrite/nitrate addition will normally attain a dull brown colour in raw products or a grey colour in heated products, which typically negatively influences consumer acceptance.

However, the metabolites of nitrites, such as nitric oxide and N-nitroso compounds, have raised concern over potential adverse health effects, and recently, the International Agency for Research on Cancer (IARC) concluded that ingested nitrates or nitrites are probable carcinogens for humans.

For now, no suitable and safe nitrite alternatives exist. These food additives should be significantly reduced but a safe alternative must be found in order to ensure the microbiological protection, the antioxidative performances, and the colour and organoleptic characteristics.

Carmine is the most frequently used food colouring agent in meat products to enhance the natural red colour of meat. However, Carmine is an insect-derived food colouring and the rapid growth in the number of consumers moving towards vegetarian and vegan food choices is encouraging the development of animal-friendly alternatives.

Beetroot is widely used as carmine alternative in cured meat products to give them an intense pink colour. However, the use of these pigments is limited largely because of their sensitivity to heat. Betanin, the beetroot pigment, is easily hydrolysed to yellow betalamic acid and cyclodopa-5-O-glycoside, mostly in basic conditions.

Anthocyanins are water-soluble plant extracts responsible for red, purple, and blue colours and mainly distributed among flowers, fruits, and vegetables.

However, the use of anthocyanins as food colourants is limited because of low stability and colour changing during processing and storage.

Additionally, the colour of anthocyanins is dependent on pH. This is because the molecular structure of anthocyanins is ionic in nature.

In acidic conditions, some of the anthocyanins appear red. Anthocyanins have a purple hue in neutral pH, while the colour changes to blue in an increasing pH condition. The red-coloured pigments of anthocyanins are predominantly in the form of flavylium cations. These anthocyanins are more stable at a lower pH solution. At lower pH, the flavylium cation formed enables the anthocyanin to be highly soluble in water. The decrease in water concentration increases the rate of deprotonation of the flavylium cation, thus reducing colour stability.

At increasing pH conditions, colourless carbinol pseudobase and chalcone structures are formed, followed by formation of anionic quinonoidal species. This is due to the kinetic and thermodynamic competition between the hydration reaction of flavylium ion. This blue quinonoidal species is unstable at lower pH.

At pH 4-5, an anthocyanin solution has very little hue due to the small amount of flavylium cation and quinonoidal anion. At neutral pH, resonance-stabilized quinonoid anions (colour purple of anthocyanins) are formed from further deprotonation of the quinonoidal species.

As the pH of meat products typically ranges from 5.5 to 6.5, anthocyanins should not have the suitable shade to replace nitrite in meat products.

Acylated anthocyanins may be more stable in acidic conditions than simple anthocyanins. Rodríguez-Saona et al. has showed than diacylated anthocyanins in red radish are stable over time, at pH 3.5 in a model juice. However, room temperature storage (25° C.) resulted in higher degradation rates as compared to refrigerated temperatures (2° C.). It is therefore likely that even acylated anthocyanin would not be stable in, for example, meat products that are cooked for several hours at over 60° C. At pH over 5-6, which is typically found in food products, the stability is likely to be considerably reduced.

The chromaticity of red radish extract at different pH values has been extensively investigated. Hypochromic effects were observed when pH increase until pH 5 and hyperchromic effects and bathochromic shifts were observed when pH increase above pH 5 (FIG. 1). The flavylium cation was hydrated to yield the colourless carbinol pseudobase at pH 3-5 and the blue quinoidal-base at pH 5-8.

At pH 3 and 5, more than 60% of anthocyanins were retained after 20 days light exposure (480 h), whereas at pH 7 anthocyanin content reduced to 40% within 1 day. During heating, the colour of red radish anthocyanin extracts disappeared and/or changed to yellow. The degradation behaviour of samples at pH 3, 5, and 7 were similar to that of light.

The listing or discussion of an apparently prior-published document in this specification should not necessarily be taken as an acknowledgement that the document is part of the state of the art or is common general knowledge.

### SUMMARY OF THE INVENTION

The applicant has surprisingly and unexpectedly found that anthocyanins and/or betanin can be used as a food colourant, in food products that have about 5% of more fat by weight of the food product and/or have a pH of about 4 or more.

Therefore, the invention provides the use of an anthocyanin and/or a betanin as a colourant in a food product, wherein the food product comprises about 5% or more fat by weight of the food product and/or has a pH of about 4 or more.

This will be referred to hereinafter as the use of the invention.

The present invention also provides a process for colouring a food product having about 5% or more fat by weight of the food product and/or has a pH of about 4 or more, wherein the process comprises the addition of an anthocyanin and/or a betanin to the food product.

This will be referred to hereinafter as the process of the invention.

### DETAILED DESCRIPTION OF THE INVENTION

The invention is related to the use (use of the invention) of one or more anthocyanin(s) and/or one or more betanin(s) as a colourant in a food product, in particular a meat, fish or to a meat analogue product, wherein the food product comprises about 5% or more fat by weight of the food product and/or has a pH of about 4 or more.

The present invention also provides a process (process of the invention) for colouring a food product (such as a meat, fish or to a meat analogue product) having about 1% or more fat by weight (such as 5% or more by weight, or 15% or more by weight) of the food product and/or has a pH of about 4 or more (such as about 5 or more, or 6 or more), wherein the process comprises the addition of one or more anthocyanin(s) and/or one or more a betanin(s) to the food product.

In certain embodiments, the process comprises the addition of one or more anthocyanin(s) containing extracts and/or one or more a betanin(s) containing extracts to the food product.

In certain embodiments, the process comprises the addition of one or more anthocyanin(s) obtained from Raphanus sativus L. and one or more betanin(s) obtained from Beta vulgaris L. to the food product.

The present inventors have surprisingly and unexpectedly found that where the anthocyanin and/or betanin are incorporated into the food product (such as a meat, fish or to a meat analogue) before or while the food product is emulsified an increase in stability of the colourant may be achieved.

In certain embodiments of the use or process of the invention, the food product is an emulsified food product, and the anthocyanin and/or betanin are incorporated into the food product before or while the food product is emulsified (step i).

In certain embodiments, further mixing or emulsification steps (step ii) may be performed after the anthocyanin and/or betanin are incorporated into the food product (step i). Also, in certain embodiments, the food product may be heated (step iii) after step I and/or after step ii.

Thus, the present invention also provides a process for colouring a food product, wherein the process comprises:
(i) Adding one or more anthocyanin(s) and/or one or more betanin(s) (such as in the form of the composition of the invention) to a meat, fish or to a meat analogue product having at least 1% by weight of fat (such as at least 5%, or at least 15%); and optionally a pH of more than 4
(ii) Emulsifying or mixing the combination obtained in step (i); and
(iii) Optionally heating the mixture obtained in step (ii).

In the case it is an emulsified product, the colouring composition of the invention may be add before or during the emulsification process, thus, the present invention also provides a process for colouring a food product, wherein the process comprises:
(i) Adding one or more anthocyanin(s) and/or one or more betanin(s) (such as in the form of the composition of the invention) to a meat, fish or to a meat analogue product having at least 1% by weight of fat (such as at least 5%, or at least 15%); during the emulsification process
(ii) Optionally further emulsifying or mixing the combination obtained in step (i); and
(iii) Optionally heating the mixture obtained in step (ii).

The anthocyanins used in the invention may be obtainable from a synthetic source or they may be obtainable from a natural source, such as from fruits, vegetables and/or flowers.

Examples of natural anthocyanins that may be used in the invention include, but are not limited to, pelargonidin-based anthocyanins, cyanidin-based anthocyanins and peonidin-based anthocyanins.

Natural anthocyanins in fruit, vegetables and flowers are typically not present in their aglycone form, but rather are present in form of anthocyanin glycosides. Therein, sugar molecules are bound via an O-glycosidic bond to a hydroxy group, usually present in the 3- and/or 5-position of the anthocyanin molecule.

Most commonly, a glycosylation is present on the 3-position and, if present, a second glycosylation is present on the 5-position. However, also a hydroxy group present at position 7, 3′, 4′ or 5′ can be subject to glycosylation. Examples of sugars commonly found in anthocyanin glycosides are glucose, galactose, arabinose, rhamnose and xylose. They can be present as single sugar molecules or in form of di- or tri-saccharides. A glycoside structure can be present in only the 3- or the 5-position of the anthocyanin molecule (monoglycoside) or can be present in both the 3- and the 5-positions thereof (diglycoside). As said above, glycosylations may also be present at other positions.

The formula below represents red radish anthocyanins (Matsufuji et al).

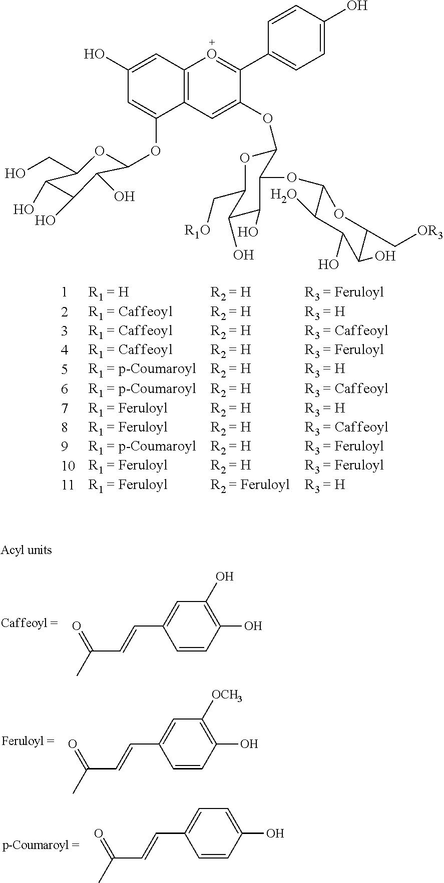

Thus, the anthocyanin(s) may be in the form of an anthocyanin glycoside.

Further to the substitution by sugar molecules natural anthocyanin glycosides can be acylated within the sugar residue structures.

An acylated anthocyanin glycoside is typically an anthocyanin glycoside where the hydroxyl group of a sugar residue is reacted with a carboxylic acid to form an ester structure, wherein the carboxylic acid is esterified with a sugar moiety. Carboxylic acids suitable for acylation of anthocyanin glycosides and frequently found in natural anthocyanins are the hydroxycinnamic acids, (such as coumaric acid, caffeic acid and ferulic acid) and malic acid.

Phenolic acids are also suitable for acylation of anthocyanin glycosides. Phenolic acids are carboxylic acids having a phenol ring and a carboxylic acid group and include benzoic acids and hydroxycinnamic acids.

Thus, the anthocyanin(s) may be in the form of an acylated anthocyanin glycoside. For example, pelargonidin-based acylated anthocyanins, cyanidin-based acylated anthocyanins and peonidin-based acylated anthocyanins or structural analogues of pelargonidin-based acylated anthocyanins, cyanidin-based acylated anthocyanins and peonidin-based acylated anthocyanins.

The stability of the acylated anthocyanin glycoside may depend on the degree of acylation. Where the acylation is provided by phenolic acid, at least 40 mol-% of all anthocyanins may be acylated by at least one phenolic acid, at least 50 mol-% of all anthocyanins may be acylated by at least one phenolic acid, at least 60 mol-% of all anthocyanins may be acylated by at least one phenolic acid, at least 70 mol-% of all anthocyanins may be acylated by at least one phenolic acid, such as at least 80 mol-%, or at least 85 mol-% or at least 90 mol-% based on all anthocyanins present. For example, from about 70 mol-% to about 100 mol-%, or from about 80 mol-% to about 90 mol-% of all anthocyanins may be acylated by at least one phenolic acid.

Where the acylation is provided by hydroxycinnamic acids, at least 20 mol-% of all anthocyanins may be acylated with at least one hydroxycinnamic acid, such as at least 50 mol-%, at least 75 mol-% or at least 99 mol-% based on all anthocyanins present. For example, from about 20 mol-% to about 100 mol-%, or from about 25 mol % to about 80 mol-%, or from about 30 mol-% to about 70 mol-% or from about 35 mol-% to about 70 mol-% of all anthocyanins may be acylated with at least one hydroxycinnamic acid.

Where the acylation is provided by malic acid, at least 20 mol-% of all anthocyanins may be acylated with at least one malic acid, such as at least 50 mol-%, at least 75 mol-% or at least 99 mol-% based on all anthocyanins present. For example, from about 20 mol-% to about 100 mol-%, or from about 25 mol % to about 80 mol-%, or from about 30 mol-% to about 70 mol-% or from about 35 mol-% to about 70 mol-% of all anthocyanins may be acylated with at least one malic acid.

The amount of pelargonidin-based anthocyanins, based on all anthocyanins present may be from about 50 mol-% to about 90 mol-%, such as from about 55 mol-% to about 85 mol-%, or from about 60 mol-% to about 80 mol-%.

The remainder of other (non-pelargonidin-based) anthocyanin(s) present may be any anthocyanin(s) as long as the total amount of anthocyanins shows the amount of acylated anthocyanins and the content of hydroxycinnamic acid acylation moieties defined above, and further shows a red-orange colour hue within the range of 10-30, preferably 15-25, measured as defined above.

As noted previously, the anthocyanins may be synthetic or they may be obtainable from a natural source, such as from fruits, vegetables and/or flowers

For example, the anthocyanins may be present as an extract obtained or obtainable from a plant from the Brassicaceae family, the Rosacae family, the Solanaceae family, the Convolvulaceae family, or mixtures thereof. By mixtures, we include a mixture where the plant from the Brassicaceae family, the plant from the Rosacae family and the plant from the Solanaceae family are extracted together using a single solvent and mixtures where the plant from the Brassicaceae family, the plant from the Rosacae family and the plant from the Solanaceae family are extracted separately and the resulting extracts combined.

The plant of the Brassicaceae family may be Raphanus sativus L. (red radish).

The plant of the Rosacae family may be the Fragaria (strawberry).

The plant of the Solanaceae family may be the Solanum tuberosum (red potato).

The plant of the Convolvulaceae family may be Ipomoea batatas (purple sweet potato root).

The betanin(s) in the use of the invention may be present as an extract obtained or obtainable from a plant of the Caryophyllales order, particularly a plant of the Amaranthaceae family, the Cactaceae family, or mixtures thereof.

The plant of the Amaranthaceae family may be Beta vulgaris L. (beetroot).

The plant of the Cactaceae family may be Opuntia ficus-indica

Both anthocyanin(s) and a betanin(s) may be present. For example, the use or process may require a combination of:
(i) extracts obtained or obtainable from a plant from the Brassicaceae family, the Rosacae family, the Solanaceae family or mixtures thereof; and
(ii) extracts obtained or obtainable from a plant of the Caryophyllales order, particularly a plant of the Amaranthaceae family, the Cactaceae family, and mixtures thereof.

In particular, the combination of an extract obtained or obtainable from a plant from the Brassicaceae family (in particular Raphanus sativus L. (red radish)) and an extract obtainable from a plant from the Amaranthaceae family (in particular Beta vulgaris L. (beetroot)) may be used. The combination may be obtained by extracting the plant from the Brassicaceae family (such as the genus Raphanus, in particular Raphanus sativus L. (red radish)) and the plant from the Amaranthaceae family (in particular Beta vulgaris L. (beetroot)) together using a single solvent or may be obtained by extracting the plant from the Brassicaceae family (in particular Raphanus sativus L. (red radish)) and the plant from the Amaranthaceae family (in particular Beta vulgaris L. (beetroot)) separately and combining the resulting extracts.

For example, the present invention provides the use of one or more anthocyanin(s) obtained from Raphanus sativus L. and/or one or more betanin(s) obtained from Beta vulgaris L. as a colourant in a food product, wherein the food product comprises about 1% or more fat by weight of the food product and/or has a pH of about 4 or more.

In a preferred embodiment the food product comprises about 5% or more fat by weight and the pH is from about 5 to 7 pH.

For example, the present invention provides the use of a Raphanus sativus L. extract comprising anthocyanin(s) and/or a Beta vulgaris L. extract comprising betanin(s) as a colourant in a food product, wherein the food product comprises about 1% or more fat by weight (such as 5% or more by weight, or 15% or more by weight) of the food product and/or has a pH of about 4 or more (such as about 5 or more, or 6 or more).

In the uses or process described herein, the fat contain of the food product may be of about 1% or more by weight, or 1.5% or more, or 3% or more, or 4% or more, or 5% or more, or 6% or more, or 10% or more, or 15% or more, or 20% or more, or 30% or more.

In the uses or process described before, the pH pf the food product may be of about 4 or more, or of about 5 or more, or of about 6 or more, or of about 7 or more, or of about 8 or more, or of about 9 or more, or of about 10 or more. In a preferred embodiment the pH is of about 6.5.

An “anthocyanin(s) comprising extract” or “Anthocyanin extract” means any natural extract comprising at least one type of anthocyanins as described before that may be derived from, e.g., but not limited to Brassicaceae family, the Rosacae family, the Solanaceae family.

A “Betanin(s) comprising extract” or a “Betanin(s) extract” means any natural extract comprising at least one type of betanins as described before that may be derived from, e.g., but not limited to Amaranthaceae family, the Cactaceae family.

The present invention also provides a composition comprising: (i) an anthocyanin extract and (ii) a betanin extract and mixtures thereof.

This is hereinafter referred to as the composition of the invention.

The present invention also provides a composition comprising: (i) an anthocyanin extract obtainable from a plant from at least one of the Brassicaceae family, the Rosacae family, the Solanaceae family and mixtures thereof; and (ii) a betanin extract obtainable from a plant of the Caryophyllales order, particularly a plant of the Amaranthaceae family, the Cactaceae family, and mixtures thereof.

The composition of the invention may be used as a food colouring composition. In particular, the composition may be used to colour meat, fish or meat analogue having a pH of at about 4 or more (such as about 5 or more, or 6 or more) and/or a fat content of at about 1% or more by weight (such as 5% or more by weight, or 15% or more by weight), preferably processed meat, fish or meat analogue having a pH of at about 4 (such as about 5 or more, or 6 or more) or more and/or a fat content of at about 1% or more by weight (such as 5% or more by weight, or 15% or more by weight).

The extracts defined above may be obtained or obtainable from the juice of the plant and then optionally dried.

Alternatively, the extract may be an aqueous extract, an alcohol extract (which includes hydro-alcoholic extracts), or an organic extract or may be an extract obtained using a combination of the aforementioned solvents. One or more purifications steps can be performed to obtain highly purified and enriched extracts.

The term “aqueous extract” as used herein, refers to the extract obtained when the extraction from the plant has been performed using water as the only solvent.

The term “alcohol extract” as used herein, refers to the extract obtained when the extraction from the plant has been performed using an alcohol as the solvent. The alcohol solvent may consist of only alcohol (e.g. 100% alcohol), for example 100% ethanol, or may be a mixture of an alcohol and water (i.e. a hydro-alcoholic solvent), for example, a mix of ethanol and water (hydro-ethanolic solvent), for example, from about 1% to about 99% alcohol (e.g. ethanol) in water, for example the ratio of water to alcohol is from 10/90% v/v to 90/10% v/v or 30/70% v/v to 70/30% v/v, such as 50/50% v/v or 70/30 v/v.

The term “organic extract” as used herein, refers to the extract obtained from a plant when the extraction has been performed using an organic solvent that is not an alcohol. For example, the organic solvent may be selected from the group consisting of acetic acid, acetone, acetonitrile, benzene, 2-butanone, carbon tetrachloride, chlorobenzene, chloroform, cyclohexane, 1,2-dichloroethane, diethylene glycol, diethyl ether, diglyme (diethylene glycol, dimethyl ether), 1,2-dimethoxy-ethane (glyme, DME), dimethyl-formamide (DMF), dimethyl sulfoxide (DMSO), 1,4-dioxane, ethyl acetate, ethylene glycol, glycerin, heptane, hexamethylphosphoramide (HMPA), hexamethylphosphorous, triamide (HMPT), hexane, methyl t-butyl, ether (MTBE), methylene chloride, N-methyl-2-pyrrolidinone (NMP), nitromethane, pentane, petroleum ether (ligroine), pyridine, tetrahydrofuran (THF), toluene, triethyl amine, o-xylene, m-xylene and p-xylene.

In the use or process of the present invention, the extract may preferably be an aqueous extract.

In the use or process of the present invention, the extract may be dried using a support such as maltodextrin.

Where the anthocyanins are provided by an extract obtainable from a natural source, such as from a plant from at least one of the Brassicaceae family, the Rosacae family, the Solanaceae family or mixtures thereof, the extract may comprise anthocyanin compounds in an amount of at least 1 wt %, or at least 5%, or at least about 10 wt %, or at least 20 wt %, or at least 30 wt %, or at least 40 wt %, or at least 50 wt %. For example from about 10 wt % to about 99 wt %, or from about 30 wt % to about 80 wt %, or from about 40 wt % to about 70 wt %, or from about 1 wt % to about 50 wt %, or from about 50 et % to about 99 wt %.

In one embodiment, the anthocyanin (0.1% in pH 3.0) such as a red radish derived colour (0.1% in water) has a L* value of 58.89+/−5%, a* value of 69.81+/−5% and b* value of 51.43+/−5%.

Typically, the extracts defined herein may only contain low levels of peonidin-based anthocyanins. For example, in the extract less than 15 mol-% of all anthocyanins of the composition are peonidin-based anthocyanins, such as less than 10 mol-% or less than 5 mol-%.

The anthocyanins may also be free of synthetic red colorants, lycopene, s-carotene, carmine, or betalains.

The anthocyanins (such as the anthocyanins obtained or obtainable from a plant from at least one of the Brassicaceae family, the Rosacae family, the Solanaceae family or mixtures thereof) may take the form of a solid, e.g., a powder; a semi-solid, e.g., a paste; or a liquid, e.g., a solution or dispersion. The anthocyanin is preferably provided in a form that is soluble or dispersible in water.

Where the Betanin(s) are provided by an extract obtainable from a natural source, such as from a plant from at least one plant of the Caryophyllales order, particularly a plant of the Amaranthaceae family, the Cactaceae family or mixtures thereof, the extract may comprise betanin compounds in an amount of at least 0.3% wt %, or at least about 5 wt %, or at least about 10 wt %, or at least about 15 wt %, or at least 20 wt %, or at least 30 wt %, or at least 40 wt %, or at least 50 wt %. For example from about 0.3 wt % to about 10 wt %, or from about 5 wt % to about 30 wt %, or from about 40 wt % to about 70 wt %, or from about 5 wt % to about 50 wt %, or from about 50 et % to about 99.9 wt %.

In certain embodiments, the betalain (0.1% in water) (such as a beetroot derived colour) has a L* value of 85.29+/−5%, a* value of 26.66+/−5% and b* value of −5.76+/−5%.

The anthocyanin(s) may be used in an amount of from about 100 ppm to about 10000 ppm, or from about 100 to about 1000, such as from about 200 ppm to about 500 ppm or about 250 ppm and the betanin may be present in an amount from about 1 ppm to about 10000 ppm, or from about 10 pm to about 500 ppm, such as from about 1 ppm to about 20 ppm or about 5 ppm.

For example, the anthocyanins may be present in the food product in an amount from about 0.1 g/kg to about 10 g/kg, such as from about 0.2 g/kg to about 0.5 g/kg or about 0.25 g/kg, and the betanin may be present in the food product in an amount from about 0.001 g/kg to about 10 g/kg, such as from about 0.001 g/kg to about 0.02 g/kg or about 0.005 g/kg.

The ratio between the anthocyanin(s) and betanin(s) may be from 100:1 to 1:100, such as from 90:1 to 1:90, such as from 80:1 to 1:80, such as from 70:1 to 1:70, such as from 60:1 to 1:60, such as from 50:1 to 1:50, such as from 40:1 to 1:40, such as from 30:1 to 1:30, such as from 20:1 to 1:20, such as from 10:1 to 1:10, such as from 9:1 to 1:9, such as from 8:1 to 1:8, such as from 7:1 to 1:7, such as from 6:1 to 1:6, such as from 5:1 to 1:5, such as from 4:1 to 1:4, such as from 3:1 to 1:3, such as from 2:1 to 1:3, such as from 1:1 to 1:3, such as from 1:1.5 to 1:2.5, such as approximately 1:2. In a preferred embodiment the ratio is such as 50:1.

The anthocyanins may be present in the composition in an amount from about 1% to about 99%, such as from about 2% to about 40% such as from about 3% to about 20% or about 5%. The betanins may be present in the composition in an amount from about 0.1% to about 99%, such as from about 2% to about 40% such as from about 0.3% to about 20%, or about 0.3%, or about 15%.

In the use, process or composition of the present invention, it may be desirable to also use an anti-oxidant and/or anti-microbial compound and/or composition.

The inventors have surprisingly found that the combination of the anthocyanin and/or betanin (composition of the invention) together with an anti-oxidant and/or anti-microbial provides better antimicrobial effects as if used alone. The combination of the colouring composition of the invention with the antioxidant and/or antimicrobial compositions of the invention provides a protection against spoilage bacteria even superior to the Nitrites alone or in combination with lactate and ascorbate/erythorbate, thus providing a complete solution for Nitrite and/or lactate and ascorbate/erythorbate replacement.

In certain embodiments of the use and process of the invention, the anthocyanin and/or betanin (composition of the invention) is used in combination with an anti-oxidant and/or anti-microbial. This is hereinafter referred to as the anti-oxidant and/or antimicrobial composition of the invention.

The anti-oxidant and/or antimicrobial composition may be added during step (i), (ii) or (iii), but is preferably performed during step (i), that is while the mixture is emulsified or before the mixture is emulsified.

In certain embodiment the anti-oxidant and/or anti-microbial compound and/or composition and the colouring composition of the invention may be formulated together as a final integrated solution.

In certain embodiment the anti-oxidant and/or anti-microbial compound and/or composition and the colouring composition of the invention may be formulated separately as a kit solution.

Particular anti-oxidants and/or anti-microbial compounds/compositions that may be used in the present invention include, but are not limited to, a Lamiaceace extract (such as a rosemary extract), ascorbic acid (such as an acerola extract), acetic acid (such as a vinegar), hesperidin, punica extract (pomegranate) and combinations thereof.

As used herein, the term “Lamiaceae extract” may refer to an extract from a plant of the Lamiaceae family (Lamiaceae material), including but not limited to rosemary, sage, oregano, thyme, mints, and the following genera: Salvia (such as Salvia apiana and Salvia officinalis), Rosmarinus (such as Rosmarinus officinalis), Lepechinia, Oreganum, Thymus, Hyssopus and any mixtures thereof.

The Lamiaceae material used for extracting the Lamiaceae extract can be any part of the plant such as leaves, roots, etc.

The Lamiaceae material may be processed before extraction, for example it can be washed, dried, milled or grounded, etc.

The rosemary extract may be obtained or obtainable by the extraction of the aerial parts of a Lamiaceae extract (such as a rosemary extract) with acetone or ethanol (for example, aqueous ethanol) followed by optional purification depending on the concentration of camosic acid required in the final extract.

Particular solvents that may be used in the extraction process include water, alcohols (such as methanol, ethanol), acetone, ethyl acetate, hexane, dichloromethane, and any mixtures thereof, such as alcohol/water mixtures (such as mixtures of methanol and water). For example, the extraction solvents can be water, a water-alcohol mixture (from about 1% to about 99% alcohol in water. For example, from about 30% to about 75% alcohol in water, or from about 30% to about 50% alcohol in water, such as from about 35% or from about 40% alcohol in water), or alcohol. Particular alcohols that may be mentioned include ethanol (EtOH) and methanol (MeOH).

In particular embodiments, the extraction solvent may be a methanol-water mix, such as from about 30% to about 90% methanol in water, or from about 30% to about 50% methanol in water. For example, from about 50% or from about 80% ethanol in water. In a preferred embodiment the extraction solvent is ethanol-water mix with about 75% methanol and about 25% water.

The term “acetone extract” as used herein, refers to the extract obtained from any member of the Lamiaceae family (such as rosemary, salvia etc) when the extraction from the plant (particularly, leaves) has been performed using acetone as the only solvent.

The term “alcohol extract” as used herein, refers to the extract obtained from Lamiaceae when the extraction from the plant (particularly, leaves) has been performed using alcohol as the only solvent. For example, 100% methanol and/or 100% ethanol. The term “hydro-alcoholic extract’ as used herein, refers to the extract obtained from Lamiaceae (such as rosemary, salvia etc) when the extraction from the plant has been performed using a mixture of water and alcohol. For example, from about 1% to about 99% alcohol (e.g. ethanol, methanol) in water, such an extract would be termed a hydro-ethanolic extract.

In one preferred embodiment, the Lamiaceae extract is a hydro-ethanolic extract.

A detailed procedure to prepare a Rosemary extract was described in the U.S. Pat. No. 5,859,293 (PCT WO96/34534), which is incorporated herein by reference in its entirely.

For example, processes for extraction and isolation of extracts of the invention may comprise (or consist essentially/consist of) the following steps:
(i) extraction of Lamiaceae leaves (such as rosemary and/or salvia which may be ground) by a suitable solvent (such as acetone or ethanol);
(ii) evaporation of the solvent; and, if required
(iii) purification of the extract (e.g. by chromatography).

In one embodiment, the temperature of extraction is in a range of from about 20° C. to about 100° C. In a particular embodiment, the temperature for extraction is in a range of from about 50° C. to about 70° C. Typically, the ratio of plant material to solvent mixture used in the extraction process varies from about 1:1 to about 1:10 on a gram to milliliter basis, such as from about 1:3 to about 1:8. The incubation period (i.e. the period during which the plant material is in contact with the solvent) is typically from about 2 hours to about 24 hours.

Mechanical energy can be applied during the extraction process. Applying mechanical energy helps to homogenize the mixture, changes the physical structure of the starting biological material and increases the extraction yields of phenolic diterpens. The amount of mechanical energy applied in the method depends on at which step applied, the type of Lamiaceae material, the amount of the starting material used in the mixture, the pH of the mixture, and the temperature of the mixture. The amount of mechanical energy also can influence the amount of time needed to complete the extraction of the

For example, the Lamiaceae material (such as rosemary and/or salvia) and the extraction solution (such as acetone or ethanol) may be mixed using techniques known in the art, for example using stirring, maceration, percolation or infusion, such as magnetic or mechanical stirring.

After the Lamiaceae material (such as rosemary and/or salvia leaves) and solvent have been incubated, the solvent is separated from residual Lamiaceae material by any suitable separation technique known in the art (like for example filtration).

Further filtration steps can be used. The solvent may be partially or totally removed by any method known in the art such as centrifugation, Rota vap, and any device allowing solvent evaporation or a liquid-liquid way of replacing the solvent. Further filtration steps can be used. For example in a preferred embodiment, aqueous sodium carbonate (NaHCCh) may be added to dissolve camosic acid and other organic acids, while base insoluble substances are precipitated out. The solution may be filtered to separate from solid, and the filtrate can be further concentrated under reduced pressure. In a further step, after finishing concentration is achieved, phosphoric acid (H3PO4) may added and the acid insoluble substances (including camosic acid, carnosol, and carnosic derivatives) are precipitated from the concentrated solution. Additionally the result may be fileted and the solid precipitate may be subsequently separated from liquid and rinsed with water to remove impurities.

In one embodiment, the Lamiaceae extract is enriched in phenolic diterpenes.

As used herein, the term “Phenolic diterpenes” may refer to camosic acid, carnosol, methylcarnosate, and other phenolic diterpene derivatives (rosmanol, isorosmanol, 11, 12-di-O-methylisorosmanol, 12-O-methylcarnosic acid, rosmanol-9-ethyl ether, circi-maritin, Methylated monooxidized product of camosic acid, genkwanin, epirosmanol, epiisorosmanol, camosic acid derivative, epirosmanol ethyl ether, cryptotanshinone) and mixtures thereof.

In some embodiment, Lamiaceae extract (such as rosemary and/or salvia extract) comprises at least about 1%, at least about 2%, at least about 3%, at least about 4%, at least about 5%, at least about 6%, at least about 7%, at least about 8%, at least about 9%, at least about 10%, at least about 15%, at least about 20%, at least about 30%, at least about 40%, at least about 50%, at least about 60%, at least about 70%, at least about 80%, at least about 90%, at least about 95%, or at least about 99 wt % of one or more phenolic diterpenes such as the ones described before. In a preferred embodiment, the Lamiaceae extract(s) that may be present in the antimicrobial and/or antioxidant composition of the invention comprises camosic acid and/or carnosol.

In a preferred embodiment, the antimicrobial and/or antioxidant composition of the invention comprises at least one Lamiaceae extract (such as rosemary and/or salvia extract) comprising at least about 35% w/w of phenolic diterpenes (such as camosic acid and/or carnosol).

In certain embodiments, the Lamiaceae extract (such as rosemary and/or salvia extract) may comprise (or consist essentially/consist of) the following phenolic diterpenes:camosic acid and/or carnosol. In certain embodiments, the ratio between camosic acid and carnosol is from 40:1 to 1:40, such as 30:1, 20:1, 10:1, 5:1 or 1:1.

In certain embodiments, the Lamiaceae extract may comprise (or consist essentially/consist of):
a) from about 1%, 5%, 10%, 15%, 20%, 25%, 30%, 35%, 40% or 45% to about 95%, 90%, 85%, 80%, 75%, 70%, 65%, 60%, 55% or 50% by weight of the final extract (w/w) of camosic acid, such as from about 20% to about 80% w/w, preferably such as from about 30% to about 50% w/w such as about 40% w/w; and/or
b) from about 1%, 5%, 10%, 15%, 20%, 25%, 30%, 35%, 40% or 45% to about 95%, 90%, 85%, 80%, 75%, 70%, 65%, 60%, 55% or 50% of carnosol by weight of the final extract (w/w), such as from about 1% to 20% w/w such as from about 2% to about 10% w/w, preferably such as from about 3% to about 5% w/w, such as about 4% w/w.

In particular embodiments, the Lamiaceae extract (such as rosemary and/or salvia extract) may be:

substantially free of other plant material (e.g. free of plant cellulose);
substantially free of plant cells; and/or
substantially free of plant cellular matter,
substantially free of toxic components like pesticides, quintozene, aflatoxins, ochratoxin A, cadmium, arsenic, lead or mercury,
substantially free of solvents
substantially free of volatile oil components.

In a particular embodiment, the Lamiacea extract is an extract wherein a majority of the volatile oil components have been removed.

As used herein, the term “volatile oil components” may refer to compounds like essential oils such as: (−)-borneol, (−)-bornyl acetate, (−)-camphor, 1,8-Cineole (eucalyptol) and verbenone.

In one embodiment the ration between the total % of phenolic diterpenes (such as camosic acid and carnosol)/Total % of volatiles oil components (such as (−)-borneol, (−)-bornyl acetate, (−)-camphor, 1,8-Cineole (eucalyptol) and verbenone) is not less than 15.

As used herein, references to a material being “substantially free” of another material may refer to the material consisting of less than 1% by weight (e.g. less than 0.1%, such as less than 0.01% or less than 0.001%, by weight) of that other material.

The Lamiaceae extract (such as rosemary and/or salvia extract) may be present in the composition in an amount from about 0.1% w/w to about 90% w/w, such as from about 1% w/w to about 25% w/w, such as from about 2% w/w to about 10% w/w, such as about 2% w/w or about 5% w/w, or such as about 20% w/w to 30% w/w, such as about 23% w/w.

The rosemary extract comprises camosic acid and/or carnosol. In a preferred embodiment, the Lamiaceae extract (such as rosemary and/or salvia extract) comprises from 1% w/w to about 99.9% w/w or camosic acid and/or carnosol, such as from about 4% w/w to about 40% w/w, such as from about 1% w/w to 5% w/w, such as about 1% w/w or about 2% w/w.

The antimicrobial and/or antioxidant composition may also comprise ascorbic acid Ascorbic acid that may be of a natural or a synthetic origin. In a preferred embodiment is obtained from a natural source rich in ascorbic acid, such as acerola, citrus, etc.

Thus, in certain embodiments, the antimicrobial and/or antioxidant composition comprises an acerola extract (such as a juice or dry juice) and it may be present in the composition in an amount from about 1% to about 90%, such as from about 2% to about 50%, such as from about 5% to about 30% or about 9% or about 25%.

The acerola (Malpighia glabra L.) extract (such as a concentrate juice) may have a concentration of ascorbic acid of at least 10% w/w, such as at least 20%, such as at least 40% w/w.

In one embodiment, the antimicrobial and/or antioxidant composition may comprise ascorbic acid in an amount from about 0.1% to about 99.9%, such as from about 1% w/w to about 25% w/w such as from about 2% w/w to about 10% w/w, such as 4% w/w, or about 5% w/w or about 9% w/w.

The acerola extract (such as a juice) may be dried using such techniques known in the art to provide an ascorbic acid rich powder.

The acetic acid may be present in the composition in an amount from about 10% to about 99%, such as from about 20% w/w to about 90% w/w, such as from about 30% w/w to about 80% w/w, such as from about 15% w/w to about 45% w/w, such as from about 15% w/w to 40% w/w, such as about 19% w/w to about 36% w/w, such as about 19% w/w or such as about 36% w/w, or about 70% w/w.

The acetic acid may be dried using such techniques known in the art to provide an acetic acid rich powder.

For example, vinegar (such as buffered vinegar or non-buffered vinegar) may be a source of acetic acid. Vinegar (such as buffered vinegar or non-buffered vinegar) may be present in the composition in an amount from about 10% w/w to about 99% w/w, such as from about 20% w/w to about 90% w/w, such as from about 30% w/w to about 80% w/w, such as from about 20% w/w to about 60% w/w, such as about 28% w/w, or such as bout 52% w/w, or about 70% w/w.

The vinegar (such as buffered vinegar or non-buffered vinegar) may be dried by any method know in the art so as to obtain an acetic rich powder containing about 50% to 90% acetic acid, such as from about 60% to about 80% acetic acid.

The antioxidant and/or antimicrobial composition may comprise hesperidin. Hesperidin composition are described in WO2016125020A2 which is incorporated herein by reference in it's entirely.

The antioxidant and/or antimicrobial composition may comprise punica extract, Punica extracts are described in WO2016125015A1 which is incorporated herein by reference in it's entirely.

In certain embodiments, the composition of the invention comprising one or more anthocyanin(s) and/or one or more betanin(s) further comprises a Lamiaceae extract (such as a rosemary extract and/or a sage extract) and ascorbic acid (such as an acerola extract, such as an acerola juice or a juice concentrate).

In certain embodiments, composition of the invention comprising one or more anthocyanin(s) and/or one or more betanin(s) further comprises a Lamiaceae extract (such as a rosemary extract and/or a sage extract) and acetic acid (such as buffered or non-buffered vinegar).

In certain embodiments, composition of the invention comprising one or more anthocyanin(s) and/or one or more betanin(s) further comprises a Lamiaceae extract (such as a rosemary extract and/or a sage extract), acetic acid (such as buffered or non-buffered vinegar) and ascorbic acid (such as an acerola extract, such as an acerola juice or a juice concentrate).

In certain embodiments, the composition of the invention comprising one or more anthocyanin(s) and/or one or more betanin(s) further comprises at least one phenolic diterpenes (such as camosic acid and/or carnosol), ascorbic acid (such as an acerola extract or juice comprising ascorbic acid or a purified ascorbic acid), and/or acetic acid (such as pure acetic acid or such as vinegar, such as a buffered or non-buffered vinegar).

In certain embodiments, the composition of the invention comprising one or more anthocyanin(s) and/or one or more betanin(s) further comprises at least one phenolic diterpene(s) (such as camosic acid and/or carnosol), ascorbic acid (such as an acerola extract or juice comprising ascorbic acid or a purified ascorbic acid) and acetic acid (such as pure acetic acid or such as vinegar, such as a buffered or non-buffered vinegar).

In certain embodiments, the composition of the invention comprising one or more anthocyanin(s) and/or one or more betanin(s) further comprises at least one phenolic diterpene(s) (such as camosic acid and/or carnosol) and ascorbic acid (such as an acerola extract or juice comprising ascorbic acid or a purified ascorbic acid).

In certain embodiments, the composition of the invention comprising one or more anthocyanin(s) and/or one or more betanin(s) further comprises at least one phenolic diterpene(s) (such as camosic acid and/or carnosol) and acetic acid (such as pure acetic acid or such as vinegar, such as buffered or non-buffered vinegar).

In certain embodiments, the composition of the invention comprising one or more anthocyanin(s) and/or one or more betanin(s) further comprises a Lamiaceae extract (such as a rosemary extract and/or a sage extract), ascorbic acid (such as an acerola extract or juice comprising ascorbic acid or a purified ascorbic acid) and/or hesperidine.

In certain embodiments, the composition of the invention comprising one or more anthocyanin(s) and/or one or more betanin(s) further comprises a Lamiaceae extract (such as a rosemary extract and/or a sage extract), ascorbic acid (such as an acerola extract or juice comprising ascorbic acid or a purified ascorbic acid) and/or a punica extract.

The antimicrobial and/or antioxidant composition may be present in the food product in an amount of from about 100 ppm to about 10000 ppm, such as from about 1000 ppm from about 6000 ppm or about 3000 ppm.

In one embodiment, the Lamiaceae extract(s) (such as a rosemary and/or salvia extract) comprises (or consist essentially/consist of) at least one phenolic diterpen (such as camosic acid and/or carnosol).

In certain embodiments of the use or process, the product (in particular a meat, fish or to a meat analogue product) the concentration of camosic acid in the final product is from about 12 ppm, 15 ppm, 20 ppm, 30, 40, 50, 60, 70, 80, 90, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30, 40, 50, 60, 70, 80, 90, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm. In one embodiment, the ratio between camosic acid and carnosol is from 40:1 to 5:1, such as 30:1, 20:1, 10:1 or 5:1.

In certain embodiments of the use or process, the product (in particular a meat, fish or to a meat analogue product), the concentration of ascorbic acid in the final product is from about 12 ppm, 15 ppm, 20 ppm, 30, 40, 50, 60, 70, 80, 90, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30, 40, 50, 60, 70, 80, 90, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm

In certain embodiments of the use or process, the product (in particular a meat, fish or to a meat analogue product), the concentration of acetic acid in the final product is from about 12 ppm, 15 ppm, 20 ppm, 30, 40, 50, 60, 70, 80, 90, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30, 40, 50, 60, 70, 80, 90, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm.

In certain embodiments of the use or process, the product (food or beverage etc) the concentration of camosic acid in the final product is from about 12 ppm, 15 ppm, 20 ppm, 30, 40, 50, 60, 70, 80, 90, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30, 40, 50, 60, 70, 80, 90, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm, the concentration of ascorbic acid in the final product is from about 12 ppm, 15 ppm, 20 ppm, 30, 40, 50, 60, 70, 80, 90, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, is 300 ppm to 200 ppm w/w, such as from 50 ppm to 1000 ppm; and/or the concentration of carnosol in the final product is from about 5 ppm, 10 ppm, 15 ppm, 20 ppm, 30, 40, 50, 60, 70, 80, 90, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm, and/or

the concentration of acetic acid in the final product is from about 12 ppm, 15 ppm, 20 ppm, 30, 40, 50, 60, 70, 80, 90, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30, 40, 50, 60, 70, 80, 90, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm

For example, the anti-oxidant and/or anti-microbial compound and/or composition may be present in an amount of from about 0.1 g/kg to about 10 g/kg, such as from about 0.5 g/kg to about 5 g/kg, such as from about 0.5 to about 2 g/kg.

Camosic acid and Carnosol may be present in the composition in an amount from about 0.1% to about 99.9%, such as from about 0.2% to about 25%, such as from about 0.5% to about 10% or about 2%.

Acetic acid may be present in the composition in an amount from about 1% to about 99%, such as from about 5% to about 70% such as from about 10% to about 30% or about 20%.

The ratio between acetic acid, ascorbic acid and camosic acid and carnosol may be from 94:3:3 to 20:40:40, such as 80:15:5 or 77:19:4.

Therefore, the invention also provides the use of an anthocyanin and/or a betanin (such as an anthocyanin obtained from Raphanus sativus L. and/or a betanin obtained from Beta vulgaris L.) as a colourant in a food product in combination with an anti-oxidant and/or anti-microbial compound and/or composition as defined previously; such as a composition comprising a Lamiaceae extract (such as a rosemary extract), an acerola extract (such a juice) and/or vinegar (such as buffered or non-buffered vinegar) or such as an antimicrobial and/or antioxidant composition comprising at least one phenolic diterpenes (such as camosic acid and/or carnosol), ascorbic acid (such as an acerola extract or juice comprising ascorbic acid or a purified ascorbic acid), and/or acetic acid (such as pure acetic acid or such as vinegar, such as a buffered or non-buffered vinegar), wherein the food product comprises about 5% or more fat by weight of the food product and/or has a pH of about 4 or more.

The present invention also provides a process for colouring a food product having about 1% or more fat (such as 5% or more, or 15% or more) by weight of the food product and/or has a pH of about 4 or more (such as about 5 or more, or 6 or more), wherein the process comprises the addition of an anthocyanin and/or a betanin (such as an anthocyanin obtained from Raphanus sativus L. and a betanin obtained from Beta vulgaris L.) to the food product in combination with an anti-oxidant and/or anti-microbial compound and/or composition, such as a Lamiaceae extract (such as a rosemary extract), ascorbic acid (such a dried acerola juice) and/or acetic acid.

The present invention also provides a composition comprising: (i) an anthocyanin extract obtainable from a plant from at least one of the Brassicaceae family, the Rosacae family, the Solanaceae family and mixtures thereof (such as an anthocyanin obtained from Raphanus sativus L.); and/or (ii) a betanin extract obtainable from a plant of the Caryophyllales order, particularly a plant of the Amaranthaceae family, the Cactaceae family, and mixtures thereof (such as Beta vulgaris L.), in combination with an antioxidant and/or anti-microbial compound and/or composition such as a rosemary extract, dried acerola juice and/or acetic acid.

In the case the coloring composition is used together with the antimicrobial and/or antioxidant composition of the invention, the invention then relates to a prices process for colouring a food product and for preserving the food product.

The anti-microbial composition of the invention may be used to reduce or inhibit the growth of Listeria, Pseudomonas and/or Salmonella genus in a food product, particularly a meat, fish product or meat analogue, such as a processed meat or processed fish product. In one embodiment the processed fish or fish product may be fresh or dried (such as an emulsified sausage, a fresh sausages or fresh ham, dry sausages or dry ham).

Listeria genus include Listeria monocytogenes (principal cause of Listeriosis) Salmonella is a genus of rod-shaped (bacillus) Gram-negative bacteria of the family Enterobacteriaceae. The two species of Salmonella are Salmonella enterica and Salmonella bongori.

In one embodiment, anti-microbial composition of the invention is effective in one or more of the following test: Total plate count (NF EN ISO 4833-1), Lactic flora (NF ISO 15214), Enterobacteria (ISO 21528-2), Pseudomonas (EN ISO 13720), ASR (NF V08-061) and Challenge test Listeria monocytogenes (NF-EN ISO 11290-2).

In certain embodiments of the use and the process of the invention, the food product, may further comprise a flavorant.

In certain embodiments of the composition of the invention, the composition may further comprise a flavorant.

By “flavorant” it is meant a composition created by a flavorist using methods known to the skilled person that is a mixture of tastants, aroma compounds and sensates. Flavorants are known to the person skilled in the art and can for example be found in S. Arctander, Perfume and Flavor Chemicals {Aroma Chemicals), Vols. 1 and 2, 1969. The term flavorant includes spice oleoresins and oils derived from any of allspice, basil, capsicum, cinnamon, cloves, cumin, dill, garlic, marjoram, nutmeg, paprika, black pepper, rosemary, and turmeric; essential oils including anise oil, caraway oil, clove oil, eucalyptus oil, fennel oil, garlic oil, ginger oil, peppermint oil, onion oil, pepper oil, rosemary oil, and spearmint oil; citrus oils such as orange oil, lemon oil, bitter orange oil and tangerine oil; alliaceous flavors including garlic, leek, chive, and onion; botanical extracts including arnica flower extract, chamomile flower extract, hops extract, and marigold extract; botanical flavor extracts including blackberry, chicory root, cocoa, coffee, kola, licorice root, rose hips, sassaparilla root, sassafras bark, tamarind, licorice, and vanilla extracts; protein hydrolysates including hydrolyzed vegetable protein (HVPs), meat protein hydrolysates, milk protein hydrolysates: compounded flavors both natural and artificial including those disclosed in S. Heath, Source Book of Flavors, Avi Publishing Co. West port. Conn., pp. 149-277, 1981, which is incorporated herein by reference in its entirety; and processed (reaction) flavors prepared through a Maillard-type reaction between reducing sugars and protein-derived components including amino acids.

If flavours are also used, the at least one flavour may be incorporated to the coloring composition of the invention and/or to the anti-oxidant and/or anti-microbial compounds and/or composition as a blend (integrated solution).

If the flavour has being provided together with the colouring composition of the invention and/or to the anti-oxidant and/or anti-microbial compounds and/or composition of the invention, then it will be incorporated to the food product as already defined previously. That is the final formula comprising the least one flavour, the colouring composition and/or to the anti-oxidant and/or anti-microbial compounds and/or composition an may be performed in step (i), that is while the mixture is emulsified or before the mixture is emulsified.

Also the at least one flavour may be presented as a separate flavour block.

Then, the process of the invention may also include the step of adding at least one flavour. This may be performed during step (i), (ii) or (iii), but is preferably performed during step (i) that is while the mixture is emulsified or before the mixture is emulsified.

In another aspect, the invention relates to a food product (such as a meat, fish or to a meat analogue product) obtained using the process of the invention.

In a preferred embodiment, said food product is substantially devoid of Nitrite, lactate and/or ascorbate/erythorbate. In a preferred embodiment the composition has less than 1.00%, more preferably less than 0.80%, less than 0.50%, less than 0.20%, less than 0.10%, even more preferably less than 0.01%, less than 0.005%, less than 0.0001% of Nitrite, lactate and/or ascorbate/erythorbate.

As described above, the food product may typically be a meat or fish product comprising about 1% or more fat (such as 5% or more, or 15% or more) by weight of the food product and/or has a pH of about 4 of more (such as about 5 or more, or 6 or more).

The fat may be fat from the meat of fish used in the process or may be added from other sources. The fat may be of animal (such as pork, beef fat etc) or vegetal origin (such as palm oil, coconut, oil, olive oil, etc), and mixtures thereof.

In particular, the meat or fish product may be a processed meat, process fish product or a meat analogue.

By the term “processed” we mean that the meat or fish has been modified away from their original form. For example, by mincing, emulsifying, curing, salting, smoking, drying or canning. Processed meat products include, but are not limited to, mixed fresh products, emulsified cooked products, brined cooked products or dried products such as bacon, ham, sausages, pate, salami, corned beef, jerky, hot dog, luncheon meat, canned meat and meat-based sauces, etc. In particular, the food product may be an emulsified food product such as frankfurter or hot dogs, cervelas, pates, etc.

The process fish may be a fish pate or fish paste, rillettes, smoked fish, pickled fish, etc. The processed meat or fish products may be cooked or uncooked. The processed meat may also include pet food products. The processes food may be also a meat analogue.

In the present invention, the food product may have been subjected to a temperature of 40° C. or above for at least 10 minutes. The food product may have been subjected to a constant temperature for at least 10 minutes, or at least 1 hour, at least 10 hours, at least 20 hours; or may be subjected to increasing temperatures for several time periods. For example, the food product may be subjected to a temperature of 50° C. during 20 min, then at 55° C. during about 10 min, then at 74° C. during about 23 min and finally cooled until 10° C. during 5 min. The relative humidity during the heating process may be from about 10% relative humidity to about 99% of relative humidity. In a preferred embodiment, the food product (such as emulsified sausages like Frankfurter or hot dogs, cervelas etc) may be subjected to a temperature of about 50° C. during about 20 min (at a 99% relative humidity), then 55° C. during about 10 min, 74° C. during about 23 min and finally cooled until 10° C. during 5 min (at 10% relative humidity). In another embodiment the temperature may be of 80° C. and the time of heating may be up to 15-16 hours (such as for cooked ham).

As noted above, the food product comprises about 1% of more fat and/or has a pH of about 4 of more. As already mentioned the fat may be originally present in the product meat or added during the processing.

Typically, the food product may have a fat content of from about 1% to about 60%, or from 5% to about 50% by weight of the product, such as from about 10% to about 40% by weight or from about 20% to about 30%.

Typically, the food product may have a pH of from about 4 to about 10, or from about 5 to about 8, or from about 6 to about 7, such as about 6.5. pH is measured by standard techniques such as a pHmeter.

In the invention, the anthocyanin and/or betanin are used as a colourant in a food product. Thus, the anthocyanin and/or betanin may be considered to be a food colourant, in particular a food-grade colourant or natural colourant.

As used herein, a “colourant” is any substance that imparts colour by absorbing or scattering light at different wavelengths or modified the colour of the food product. A “food-grade colorant” refers to a colorant suitable for use in a food product intended for human or animal consumption, and is differentiated from a nontoxic material that may provide colour, but is generally not included in a food product or is only included in a trace amount. The term, “natural colourant,” includes colorants that exist in or are produced by nature or are sourced therefrom.

In the use or process of the invention, the anthocyanin and/or betanin provide a food product with an L* from about 60 to about 70, a* from about 10 to about 18, and b* from about 5 to about 15.

L*a*b* values consist of a set of coordinate values which define a colour space by way of a three-dimensional Cartesian coordinate system. L* is the value, or lightness, coordinate. L* provides a scale of lightness from black (0 L* units) to white (100 L* units). a* and b* are coordinates related to both hue and chroma. a* provides a scale for greenness (−a* units) to redness (+a* units), with neutral at the center point (0 a* units), on a horizontal axis. b* provides a scale for blueness (−b* units) to yellowness (+b* units), with neutral at the center point (0 b* units), on a second horizontal axis perpendicular to the first horizontal axis. The three axes cross where L* has a value of 50 and a* and b* are both zero.

The Hue Angle is the associate of a* and b*.

In the use or process of the present invention, the anthocyanin and/or betanin provides a food product with a Hue Angle of from about 0° to about 60° or from about 20° to about 50° or from about 30° to about 40°.

In the present invention, before being used in a food product, the anthocyanin and/or betanin (for example, the anthocyanin/betanin in the form of an extract, such as in the composition of the invention) provide a Hue Angle of from about 300° to about 60°, such as from about 330° to about 30° (i.e. from about 330 to about 360° and about 0° to about 30°), when placed in a solution.

The inventors of the present invention have surprisingly found that the colour of sausages comprising the colouring composition of the invention (anthocyanins obtained from Raphanus sativus L. and betanins obtained from Beta vulgaris L.) seemed to be more stable over time than nitrite sausage colour (see example 1.2)

In particular, an increase in stability has been found for anthocyanins obtained from Raphanus sativus L. and betanins obtained from Beta vulgaris L. and combinations thereof.

For example, in the use or process of the invention the anthocyanin and/or betanin may provide a product with an L* from about 60 to about 70, a* from about 10 to about 18, and b* from about 5 to about 15. In a preferred embodiment said colour hue Angle is stable for 5 days or more, for 7 days or more, such as about 14 days or more or about 21 days or more. For example, the anthocyanin and/or betanin may provide a product with an L* from about 60 to about 70, a* from about 10 to about 18, and b* from about 5 to about 15 from about 5 days to about 28 days, or from about 14 days to about 21 days.

In the use or process of the invention, the stability of the L*, a*, b* may be achieved even if the food product has been cooked, i.e. subjected to a temperature of 40° C. or above for at least 10 minutes, such as to a temperature of above 50° C., or of above of 60° C., or of above of 70° C.

For example, the food product may have an L* from about 60 to about 70, a* from about 10 to about 18, and b* from about 5 to about 15 before being cooked and an L* from about 60 to about 70, a* from about 10 to about 18, and b* from about 5 to about 15 after being cooked.

Colorants are analysed with a spectrophotometer, and CIELAB L*a*b* values are calculated from the spectral data. The L*a*b* and L*C*h° values provide a means of representing colour characteristics and assessing the magnitude of difference between two colours.

Depending on the final product and the color desired, other colorants (such as natural colorants) may be added. For example orange colors like carotenoids (such as paprika extracts, carrot extracts, etc) may be also added to the couloring composition of the invention.

The food product obtained (meat, fish or meat analogue) using the process of the invention may have a pH of about 4 or more after step (i), (ii) and/or step (iii). The different anthocyanins and betanins that may be used in the present process have being described previously. In one embodiment, the food product has an L* from about 60 to about 80, a* from about 10 to about 18, and b* from about 5 to about 15. In a preferred embodiment the colour hue mentioned before is stable for 5 days or more, for 10 days of more, such as 21 days or more.

The present invention also provides a food product obtainable by the process described herein.

The antimicrobial composition of the invention may be used alone or in combination with the anthocyanins and/or betanin described above, for example in form of a kit as described herein.

### Kit

The invention also provides a kit.

In one embodiment the kit comprises: (i) the couloring composition of the invention and/or (ii) the antioxidant and/or antimicrobial composition of the invention and instructions for contacting different components with a foodstuff to reduce oxidation of the foodstuff, reducing microbial growth and/or obtaining a desired color.

Optionally, the kit may also further comprise (iii) at least one flavour or a flavour composition.

The three components (i), (ii) and/or (iii) may be formulated separately or together (such as (i)+(ii), such as (i) and separately (ii), such as (i)+(ii) and separately (iii), or such as (i)+(iii) and separately (ii), or (ii)+(iii) and separately (i), or (i)+(ii)+(iii))

In some embodiments, the separate compositions are marketed as a kit comprising the separate compositions or the different formulations as defined before (such as (i)+(ii) and separately (iii), or such as (i)+(iii) and separately (ii), or (ii)+(iii) and separately (i), or (i)+(ii)+(iii)) and instructions for their use to reduce the oxidation of a foodstuff, reduce microbial growth and/or obtaining a desired color.

In a preferred embodiment, when the product (foodstuff) is a emulsified product (such as a cold emulsified sausage) the components (i), (ii) and/or (iii) are added to the food matrix before or during the emulsification process.

For the avoidance of doubt, preferences, options, particular features and the like indicated for a given aspect, feature or parameter of the invention should, unless the context indicates otherwise, be regarded as having been disclosed in combination with any and all other preferences, options particular features and the like as indicated for the same or other aspects, features and parameters of the invention.

The term “about” as used herein, e.g. when referring to a measurable value (such as an amount or weight of a particular component in the reaction mixture), refers to variations of ±20%, ±10%, ±5%, ±1%, ±0.5%, or, particularly, ±0.1% relative to the specified amount. For example, a variation of ±0.5% with regards to the percentage of a component in the composition of the invention, means a variation of 0.5% relative to the percentage given, i.e. ±0.5% of 10% would mean a variation from 9.5% to 10.5%.

### FIGURES

FIG. 1: Anthocyanin absorbance spectra.

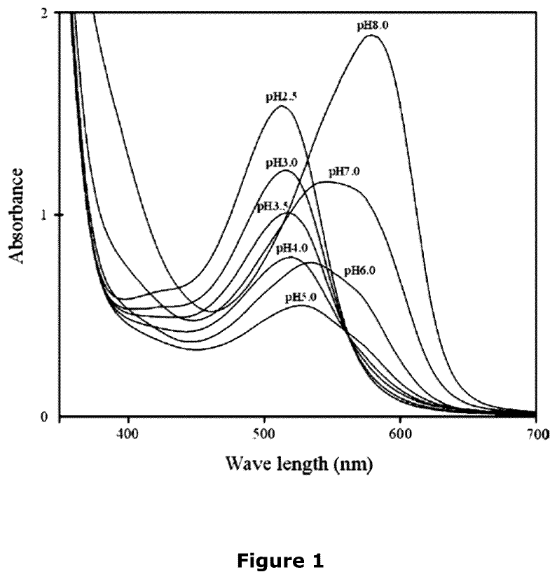

FIG. 2: The L* value of sausages over time.

FIG. 3: The *a value of sausages over time.

FIG. 4: The b* value of sausages over time.

FIG. 5: Chromaticity diagram at d0 and d21.

FIG. 6: Hue angle over time.

FIG. 7: Delta a* of sausages between d0 and d21.

FIG. 8: Delta E of sausages between d0 and d21.

FIG. 9: a* value at d0, comparison of process A and process B.

FIG. 10: a* value at d21, comparison of process A and process B.

FIG. 11: pH of all modalities.

FIG. 12: a* value during the shelf-life.

FIG. 13: Total plate counts in emulsified sausages during storage testing different conditions of blends

FIG. 14: Total plate counts in emulsified sausages during storage testing alternatives of buffered vinegar

FIG. 15: Lactic acid bacteria in emulsified sausages during storage testing alternatives of buffered vinegar

FIG. 16: Listeria growth during the shelf-life in emulsified sausages.

FIG. 17: Listeria growth during the shelf-life in fresh ground sausages.

FIG. 18: Growth differences between day 0 and day 4, and between day 4 and day 8 in fresh ground sausages

### EXAMPLES

### Material & Methods

### 1. Plant Extracts

Red radish root (Raphanus sativus L.) was extracted with water and the liquid extract was dried on maltodextrin. The powder obtained was formulated on invert sugar syrup and water to obtain a standardized liquid extract with 4% of anthocyanins.

The juice of red beetroot (Beta vulgaris L.) was dried on maltodextrin to obtain a standardized powder extract with 0.3% of betanin.

Purple sweet potato root (Ipomoea batatas L.) was extracted with water and then purified by ethanol. The extract was dried on maltodextrin.

The blends were designed to ensure the antioxidant and antimicrobial functions of nitrite. These products are blends of three natural extracts: an extract of rosemary, a juice of acerola and vinegar.

See table 1 for proportion of each extracts in blends.

Camosic acid+carnosol from the rosemary extract were present in the blend in an amount of about 1%, ascorbic acid from the acerola juice in an amount of about 4%, and acetic acid from vinegar in an amount of about 19%.

TABLE 1
Composition of blends tested

| | Natstabil | Natstabil | Rosemary/ | Rosemary | Rosemary, | Rosemary, |
|---|---|---|---|---|---|---|
| | M2 | M2 | Acerola | FF/Acerola | Acerola, | Acerola, |
| Qty % | Blend 1 | Blend 2 | blend 1 | blend 2 | Pomegranate | Citrus |
| Buffered | 68 | 68 | — | — | — | — |
| vinegar | | | | | | |
| Rosemary | 2.6 | — | 2.6 | | 2.6 | 2.6 |
| additives 59% | | | | | | |
| carnosic acid | | | | | | |
| Rosemary | — | 13.4 | — | 13.4 | — | — |
| Flavor 6% | | | | | | |
| carnosic acid | | | | | | |
| Acerola juice | 9.4 | 9.4 | 9.4 | 9.4 | 9.4 | 9.4 |
| powder (34% | | | | | | |
| ascorbic acid) | | | | | | |
| Carrier | 20 | 9.2 | 88 | 77.2 | 53.1 | 18 |
| Maltodextrin | | | | | | |
| Citrus | — | — | — | — | — | 70 |
| hesperidin | | | | | | |
| (75%) | | | | | | |
| Pomegranate | — | — | — | — | 17 | — |
| extract | | | | | | |
| (punicalagins | | | | | | |
| >4, ellagic | | | | | | |
| acid 0.5-1%) | | | | | | |

The rosemary aerial parts (historically named as Rosmarinus officinalis L., taxonomic change in Salvia rosmarinus Spenn.) were extracted with acetone at reflux. After the extraction was completed, the acetone extract was filtered to separate the solution from rosemary leaf and concentrated under reduced pressure to make concentrated native extract. At this time, the concentrated extract can be dried directly in a vacuum oven under mild heat to make a powdered extract, which is a composition comprising about 2%-10% camosic acid and carnosol.

Alternatively, to the concentrated native extract, aqueous sodium carbonate (NaHCO₃) was added to dissolve camosic acid and other organic acids, while base insoluble substances were precipitated out.

The solution was filtered to separate from solid, and the filtrate was further concentrated under reduced pressure. Once finishing concentration is achieved, phosphoric acid (H₃PO₄) was added and the acid insoluble substances (including camosic acid, carnosol, and camosic derivatives) were precipitated from the concentrated solution. Charcoal active is used during the process to decolorize the rosemary extract in solution before filtration. Through filtering, the precipitated solid was subsequently separated from liquid and rinsed with water to remove impurities.

Last, the solid was dried in a vacuum oven and then milled into powder to make a composition containing about 40-80% camosic acid and carnosol.

Acerola cherry juice (Malpighia glabra L.) was dried to obtain an ascorbic acid-rich powder containing about 20-40% ascorbic acid.

Vinegar was dried to obtain an acetic acid-rich powder containing about 60-80% ascorbic acid.

### 2. Colour and Stability Study in Solution

Red radish and purple sweet potato extracts were dissolved in buffer solutions pH 3 and pH 6. These solutions are storage over 21 days. The color was measured by L*a*b* on the first day and after 21 days.

### L*a*b*

Chromametric analysis was performed by a chromameter Minolta CR100 in the color space CIE L*, a*, b* on the internal part of the meat product (sausage).

Color changes (L*a*b*) during storage were measured at day (d) 0, d8, d14 and d21.

### 3. Emulsified Cooked Sausage Formulation and Processing

All the modalities are summarized in the Error! Reference source not found. below.

The extracts blends ensured the antioxidant and antimicrobial functions of nitrite, lactate and ascorbate/erythorbate. Red radish, beetroot and purple sweet potato extracts ensured the coloring function of nitrite and carmine.

TABLE 2
Modalities tested in emulsified cooked sausage

| | |
|---|---|
| 1 | Negative control without nitrite, lactate, erythorbate, carmine |
| 2 | Positive control Nitrite/Erythorbate |
| 3 | 3000 ppm Natstabil M2 blend1 + 4000 ppm Red Radish |
| 4 | 3000 ppm Natstabil M2 blend1 + 4000 ppm |
| | Red Radish + 1500 ppm Beetroot |
| 5 | 3000 ppm Natstabil M2 blend1 + 4000 ppm Purple sweet potato |
| 6 | 3000 ppm Natstabil M2 blend1 + 4000 ppm Beetroot |
| 7 | 3000 ppm Natstabil M2 blend1 + 1000 ppm Red |
| | raddish + 1000 ppm Beetroot + 500 ppm Flavor |
| 8 | 3000 ppm Natstabil M2 blend1 + 1000 ppm |
| | Red raddish + 1000 ppm Beetroot |
| 9 | 3000 ppm Natstabil M2 blend1 |
| 10 | 3000 ppm Rosemary/Acerola blend1 |
| 11 | 3000 ppm Rosemary FF/Acerola blend2 |
| 12 | 3000 ppm Rosemary, Acerola, Pomegranate |
| 13 | 4000 ppm Rosemary, Acerola, Citrus |
| 14 | 3000 ppm Rosemary, Acerola Blend 1 + vinegar 8% |

The emulsified cooked sausage ingredients are summarized in the Error! Reference source not found. below.

TABLE 3
Emulsified cooked sausage ingredients

| | |
|---|---|
| Pork meat % | 56% |
| Pork fat % | 24% |
| Water + Ice % | 20% |
| Salt g/kg | 18 |
| White Pepper g/kg | 2 |
| Garlic powder g/kg | 1 |
| Nutmeg powder g/kg | 0.5 |
| Coriander powder g/kg | 1 |
| Dextrose g/kg | 5 |
| Lactose g/kg | 5 |
| Plasma g/kg | 10 |
| Polyphosphates g/kg | 5 |
| Erythorbate g/kg | 0.5 |
| Nitrite salt g/kg | 18 |
| Extract Blends | according to table 2 |

For each modality, 8 kg of sausage were produced. Two emulsion processes were tested for each modality.

During the Process A, pork meat and salt were ground firstly, then polyphosphates were added. In the next step, water and ice were added and mixed with the ground meat. To emulsify the product, pork fat was then added and ground. Finally, spices, natural extracts, sugars and plasma were incorporate in this emulsion.

During the Process B, pork meat and salt were grounded firstly, then polyphosphates and natural extracts were added. In the next step, water and ice were added, then pork fat, spices, sugars and plasma and the product was emulsified.

After the emulsion process, the mix was embossed in a VISCOFAN skinless cellulose casing (21 mm diameter).

Sausages were then cooked at 99% of relative humidity at 50° C. for 20 min, 55° C. for 10 min, 74° C. forring 23 min and finally cooled to 10° C. for 5 min (10% relative humidity).

A part was inoculated on surface with Listeria monocytogenes for the challenge test and the other part was kept safe for shelf life microbiological study as well as organoleptic and physical characterization. Cooked emulsified sausages were then stored in vacuum packaging.

### 4. Fresh Sausage Formulation and Processing

All the modalities are summarized in the Error! Reference source not found. below.

The extracts Blend 1 and Blend 2 ensured the antioxidant and antimicrobial functions of nitrite, lactate and ascorbate/erythorbate.

TABLE 4
Modalities tested in fresh sausage

| | |
|---|---|
| 1 | Control without nitrite, lactate, erythorbate |
| 2a | Nitrite/Erythorbate |
| 2b | Lactate/Erythorbate |
| 3 | 3000 ppm NatStabil M2 blend 1 |
| 4 | 4000 ppm NatStabil M2 blend 1 |
| 5 | 2000 ppm NatStabil M2 blend 2 |
| 6 | 3000 ppm NatStabil M2 blend 2 |

Fresh sausage ingredients are summarized in the Error! Reference source not found. below.

TABLE 5
Fresh sausage ingredients

| | |
|---|---|
| Pork meat 4D % | 86% |
| Pork fat % | 14% |
| Salt g/kg | 18 |
| Pepper g/kg | 1 |
| Garlic powder g/kg | 0.3 |
| Dextrose g/kg | 4 |
| Lactose g/kg | 1 |
| Water + Ice g/kg | 55 |
| Erythorbate g/kg | 0.5 |
| Nitrite salt g/kg | 18 |
| Lactate g/kg | 25 |
| Extract Blends | according to table 4 |

For each modality, 6 kg of ground pork were produced.

Pork meat was ground with fat and with all the other ingredients.

A part of the ground meat was inoculated with Listeria monocytogenes for the challenge test, homogenized and embossed. The other part was kept safe and embossed for organoleptic and physical characterization. Fresh ground sausages were then conditioned in a modified atmosphere packaging (MAP) containing 80% O₂ and 20% CO₂.

### 5. Microbiological Analysis

Microbiological analysis was performed according to current standard EC regulation 2073/2005, at d0 after packaging, several days during the storage (from D4 to D7 or D14 according to the studies).

For fresh ground sausage, 10 days of shelf-life with 4 days of storage at 4° C. and 6 days at 8° C., to simulate a break in the cold chain (standardized method NF V01-003)

For cooked emulsified sausage, 14 days of shelf-life with 7 days of storage at 4° C. and 7 days at 8° C., to simulate a break in the cold chain (standardized method NF V01-003).

Group of microorganisms counts performed are listed below:
Total plate count (NF EN ISO 4833-1),
Lactic acid bacteria (NF ISO 15214) both mesophilic and psychotrophic
Enterobacteriaceace (ISO 21528-2),
Pseudomonas sp. (EN ISO 13720),
Brochothrix thermosphacta
Anaerobic enumeration of sulfito-reducing bacteria (NF V08-061),
Challenge test Listeria monocytogenes (NF-EN ISO 11290-2).
Challenge test Salmonella (NF-EN ISO 6579-1).

Logarithmic values of Listeria growth (log CFU/g) were calculated for each experiment and treatment.

Differences of logarithmic values of Listeria growth (log CFU/g) between the meat treated with plant extracts (or nitrite or lactate) and the untreated control were calculated to yield a final result. The more negative value was obtained, the higher was the antilisterial effect of the extract or of the combination of extracts. In meat science microbiology, for a given time, values are considered to be significant between two series when a difference of 0.5 Log 10 CFU/g is observed (Chaillou et al., 2014); (Guide pour la validation de methodes d'essais microbiologiques et revaluation de leur incertitude de mesure dans les domaines de la microbiologie alimentaire et de l'environnement), Schweizerische Eidgenossenschaft, Confederation Suisse, Departement federal de reconomie, de la formation et de la recherche DEFR, Document No. 328, April 2013, Rev. 03). In microbiology, it will be noted that a treatment has a significant antibacterial effect if its effect exceeds −0.5 log CFU/g as compared to the untreated control.

### Results & Discussion

### 1.1 Color & Stability Study in Solution

In buffered solution, red radish and purple sweet potato are bright red and stable at pH 3. However, at pH 6, red radish and purple sweet potato become purple.

After 21 days of storage at pH 6, the purple color is degraded in pale brownish purple, with ΔE (color difference between after and before storage) at 7.37 and 13.84 respectively, which represent important color differences.

### 1.2 Color & Stability Study in Emulsified Sausage

Before cooking, the control meat was light pink (1) and meat with nitrite was grey (2) (usual shades). With red radish extract (3), beetroot extract (6) and mixture thereof (4), the meat had a slightly more intense pink shade than control. With purple sweet potato (5), meat was intense purple.

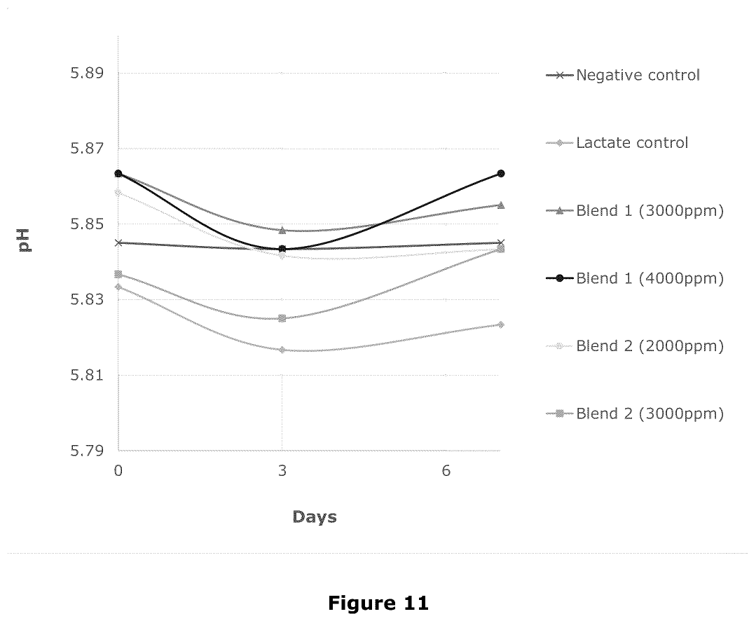

Dispersibility of all extracts was correct and meat color was homogenous. Moreover, extracts adding did not influence meat pH (Error! Reference source not found. and FIG. 11).

It is surprising that red radish modalities revealed pink shades and not purple shades at the pH found in meat. These results are not in line with the previous study in buffer solutions and the bibliographic data. The difference between red radish and purple sweet potato could be due to the composition of the anthocyanins. Major anthocyanins in both extracts are acylated but purple sweet potato is richer in acylated peonidin glycosides and acylated cyaniding glycosides, while red radish is richer in acylated pelargonidin glycosides.

TABLE 6
pH of all modalities before and after cooking

| | pH before | pH after | pH | pH | pH |
|---|---|---|---|---|---|
| Modalities | cooking | cooking d0 | d7 | d14 | d21 |
| 1-Control | 6.28 | 6.42 | 6.41 | 6.45 | 6.44 |
| 2-Nitrite | 6.31 | 6.48 | 6.43 | 6.47 | 6.47 |
| 3-Red Radish | 6.27 | 6.47 | 6.41 | 6.45 | 6.46 |
| 4-Red Radish + Beetroot | 6.25 | 6.43 | 6.41 | 6.45 | 6.46 |
| 5-Purple Sweet Potato | 6.23 | — | 6.41 | 6.45 | 6.44 |
| 6-Beetroot | 6.27 | — | — | 6.46 | 6.41 |

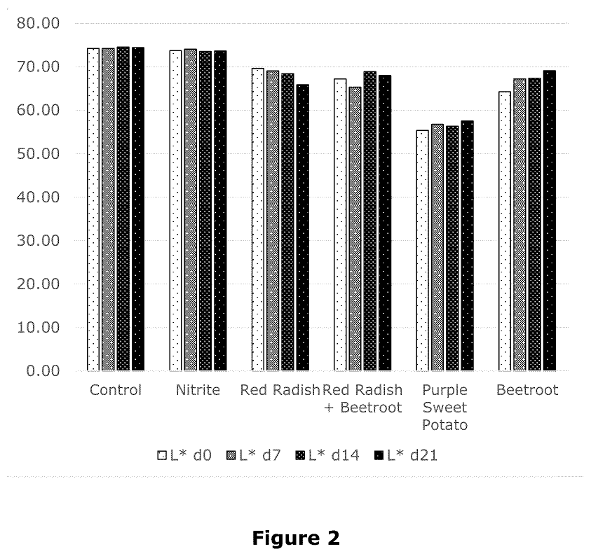

After cooking, the control was grey (1) and sausage with nitrite was light pink (2) (usual shades). With the red radish extract (3) and mixture (4), only a slight loss of color was observed. This loss gave a colour similar to the nitrite control (FIG. 2). With the beetroot extract (6), sausage was light pink close to colour provided by nitrite but with an orange shade. With the purple sweet potato extract (5), the sausage was pale purple. The extracts did not influence meat pH (Error! Reference source not found.).

It is surprising that red radish modalities displayed the exact nitrite-like pink shade after cooking; this is not in line with the previous study in buffer solutions and the bibliographic data.

After 21 days of storage (10 days at 4° C. and 11 days at 8° C.), the control was still grey (1) and shade of sausage with nitrite (2) seemed to be slightly degraded (pale orange shade). The sausages prepared with red radish extract (3) and the mixture (4) were surprisingly still pink; the color seemed to be more stable over time than nitrite sausage color.

The shade of the sausage with the beetroot extract (6) was degraded in pale orange and sausage with purple sweet potato extract (5) was still purple.

The extracts did not influence meat pH (Error! Reference source not found.).

This last result is also surprising because the color was stable during the 21 days of storage although the sausage pH was above 6. This unusual stability could be due to the acylation of anthocyanins, however, the literature showed that acylated anthocyanins were not stable at pH 7.

These visual observations can be confirmed by L*a*b* measurements.

L* value, the lightness from black (0) to white (100), was stable over time for all modalities (FIG. 2).

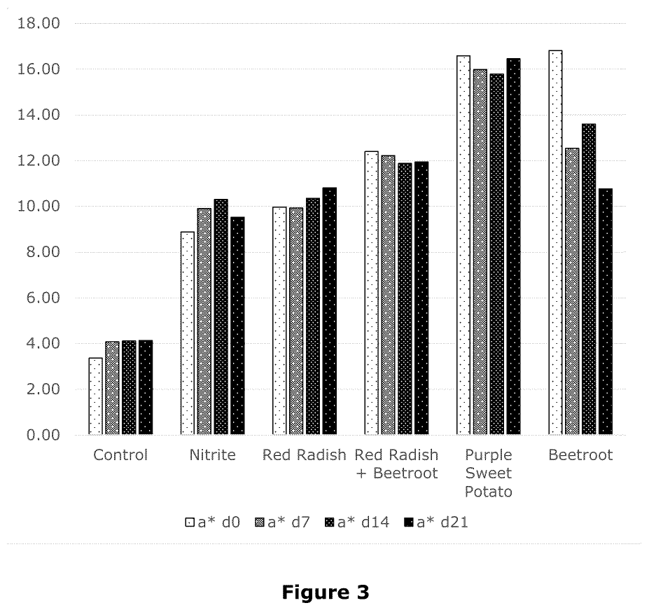

Regarding a* value (from green (−) to red (+)), control showed weak a* values, stable over time, which confirm the normal grey color observed (FIG. 3). Nitrite modality presented a* values more important than control, stable over time, which confirm normal pink color observed.

Modalities with red radish (3) and mixture (4) showed a* values very close to nitrite modality and stable over time. Furthermore, purple sweet potato modality (5) displayed the most important a* values, stable over time. However, beetroot modality (6) showed an important a* value at d0 but this value was not stable over time. This indicates that pink color was not stable and confirm the visual observations and the bibliographic data.

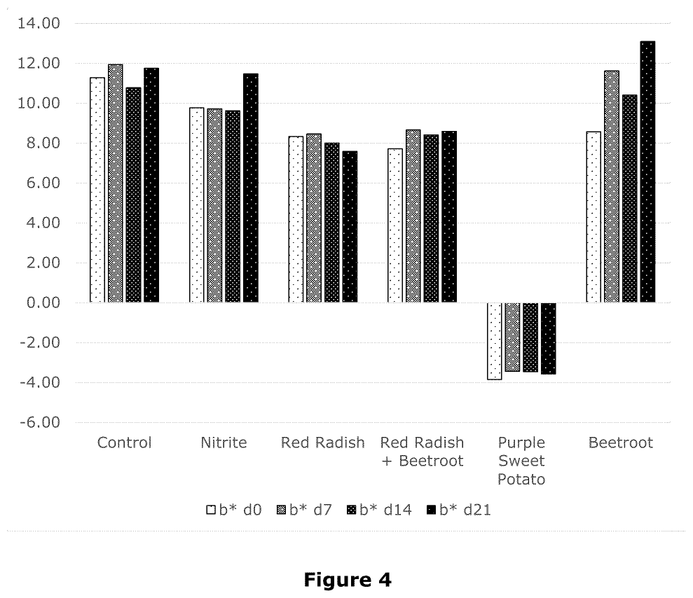

Concerning b* value (from blue (−) to yellow (+)), control was stable over time (FIG. 4).

Nitrite modality showed a slight increase of b* value at d21, which confirm the slight color degradation observed (orange shade). Modalities with red radish (3) and mixture (4) showed b* values very close to nitrite modality, slightly lower and even more stable over time, which confirms the stable and intense pink color observed. However, purple sweet potato modality (5) displayed a negative b* value, which indicate a blue shade and confirm the purple color observed. Furthermore, beetroot modality (6) showed an increase of b* value over time, which indicates that pink color is degraded in orange and confirms the visual observations and the bibliographic data.

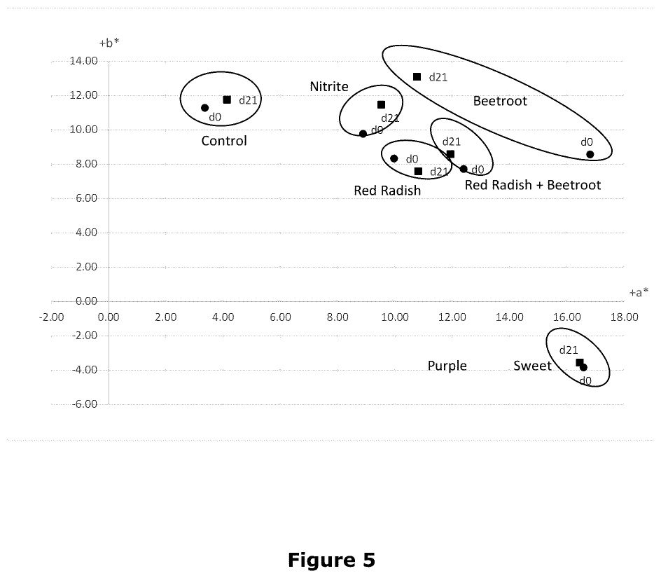

In order to illustrate L*a*b* measurement in two dimensions, FIG. 5 expose a part of the chromaticity diagram for all modalities at d0 and d21. It is obvious that control, nitrite, red radish, blend and purple sweet potato modalities had a stable shade over time, with values at d0 and d21 very close. However, for beetroot alone, there was an important shift between d0 and d21 values. This observation confirms the instability of the beetroot pink color.

In summary, the results and figures confirm the surprising results that the combination of red radish+beetroot extracts provide a good colour shade, and also provide high colour stability, that are better than nitrite, and also better than would have been predicted from the colour and stability of the extracts on their own. This demonstrates a synergistic effect. The results and figure also show that although the purple sweet potato extract did not provide the require colour, the colour was highly stable.

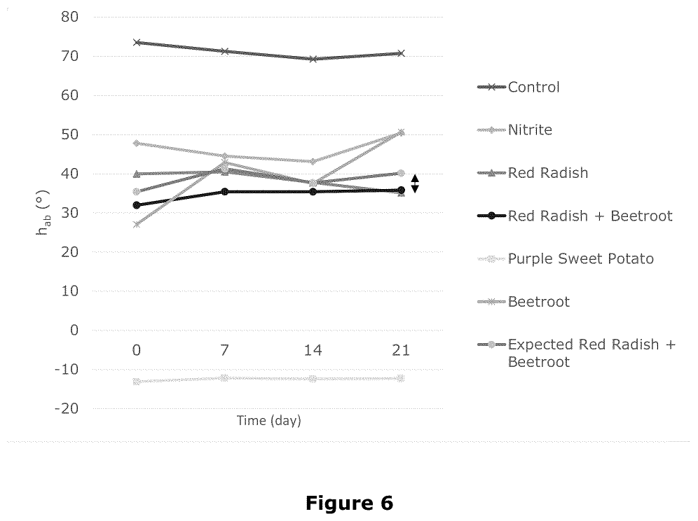

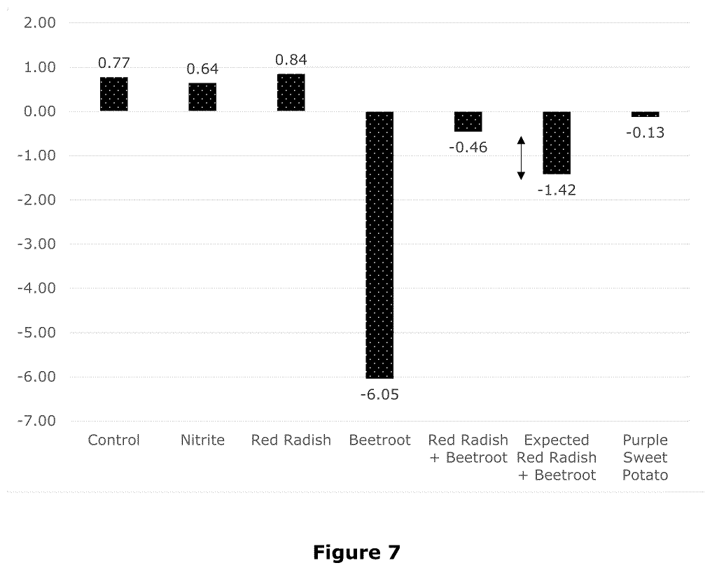

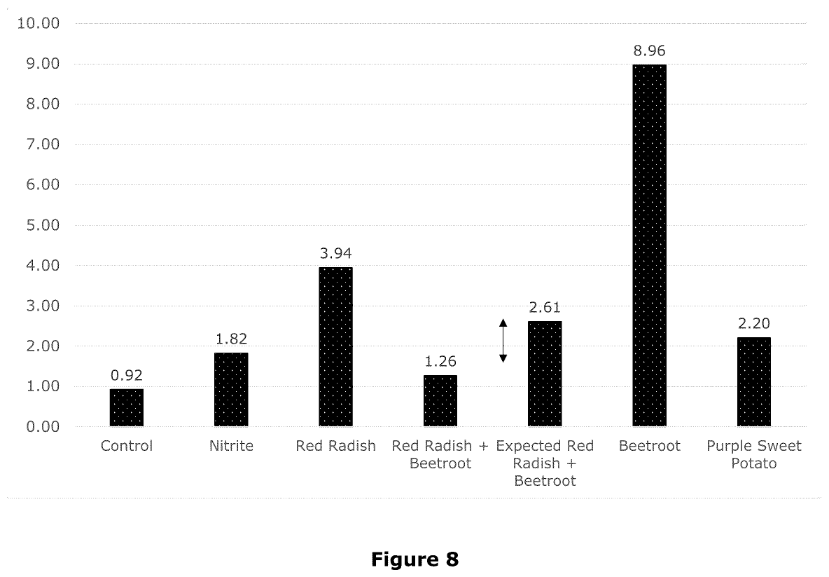

Combining Hue Angle (FIG. 6), delta a* (FIG. 7) and delta E (FIG. 8) calculations, we can confirm L*a*b* observations.

The Hue Angle gives a numerical estimate of the color of the sausages. The hue sequence on a CIELAB diagram is defined with red-purple (0°), yellow (90°), bluish-green (180°) and blue (270°).

The hue angle may be defined as the angle between the hypotenuse and 0° on the a* axis; h is calculated from the arctangent of b*/a*. Arctangent, however, assumes positive values in the first and third and negative values in the second and fourth quadrants. For a useful interpretation, h° should remain positive between 0° and 360° of the color sheel. h° is calculated following the equation below:

h°_{ab}=degrees(arctangent(b*/a*))

The control had an important hue angle value (≈70°), which confirms the pale yellow shade (FIG. 6).

Nitrite, red radish extract, the mixture of red radish extract and beetroot juice, and the beetroot juice had intermediate values (≈25-50°), which confirms the pink shade of all these modalities. It is important to notice that the beetroot juice hue angle increased during time, which confirms the lack of stability of this product alone.

At the contrary, red radish extract and the mixture of red radish extract and beetroot juice had a perfectly stable hue angle, more pink than beetroot alone and nitrite. Concerning the mixture of red radish extract and beetroot juice, the calculation of expected values (added in the FIG. 6) showed that expected color was more orange and less stable than obtained color.

This difference in Hue Angle reveal a synergistic behavior between red radish extract and beetroot juice and could be attributed to interaction of betanin with anthocyanins or other unknown compounds (intermolecular co-pigmentation).

This synergistic result is also visible with delta a* (Δa*) calculation (FIG. 7) and delta E (ΔE) calculation (FIG. 8).

Delta a* gives the difference of a* between day 0 and day 21 following the equation below:

Δa*=a*_{d21}−a*_{d0}

Where a*_{d21} is a* value at day 21 and a*_{d0} is a* value at day 0.

Delta E (ΔE) gives the difference of L*, a* and b* between day 0 and day 21 following the equation below:

ΔE=\sqrt{(L*_{21d}−L*_{0d})+(a*_{21d}−a*_{0d})+(b*_{21d}−b*_{0d})}

Where L*a*b*_{21d} are the coordinates at day 21 and L*a*b*_{0d} are the coordinates at day 0.

The Control modality, the Nitrite modality, the red radish extract, the mixture of red radish extract and beetroot juice, and the purple sweet potato extract were stable during time with a Δa*<1. However the beetroot juice alone displayed a Δa*=−6.05, showing an important colour degradation (red decreasing). Thus, the mixture of red radish extract and beetroot juice should be less stable than observed, the calculation of expected value indicated a Δa*=−1.42 whereas the observed value was only −0.46. This difference of 1 point confirmed the synergistic behavior between red radish extract and beetroot juice.

In the same manner, red radish extract showed a ΔE=3.94 and beetroot juice showed a ΔE=8.96. The calculation of expected value of the mixture of red radish extract and beetroot juice indicated a ΔE=2.61 whereas the observed value was only 1.26. Here again, this difference of more than 1 point confirmed the synergistic behavior between red radish extract and beetroot juice.

Further organoleptic studies were done. It was shown that the combination of red radish extract and beetroot juice when compared to a standard reference, do not modify the smell and taste of the final product (such as hot dogs or fresh sausages).

### 1.3 Comparison of Process a and Process B of Emulsified Sausages

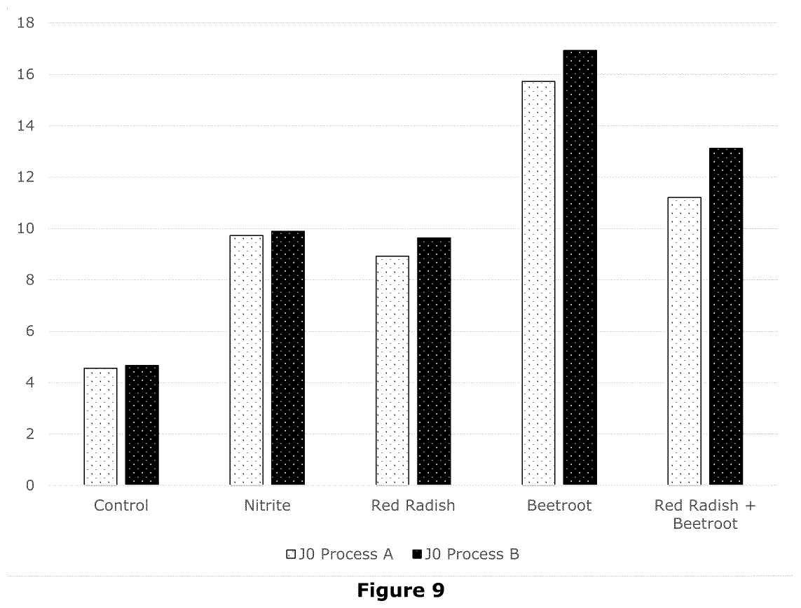

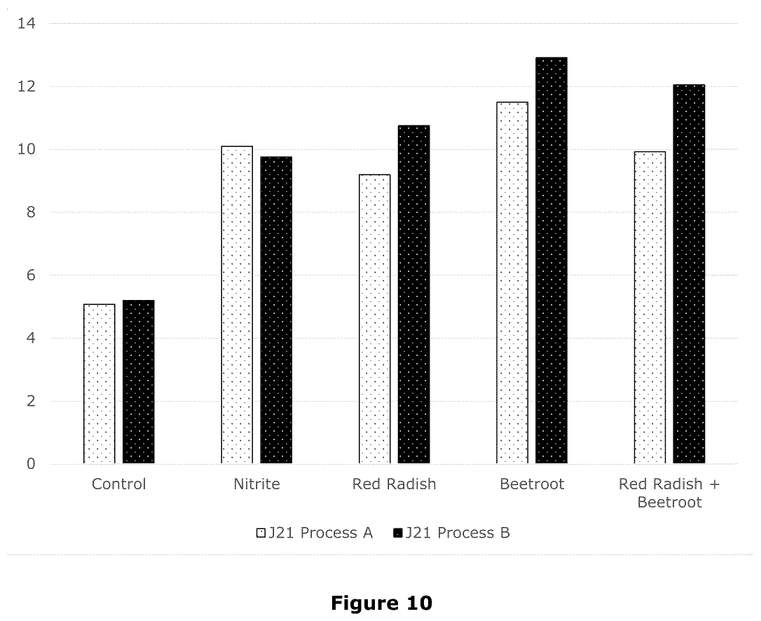

Both emulsification processes were performed and final color of cooked sausage was measured by L*a*b* at d0 and d21 (FIG. 9 and FIG. 10).

Concerning the control and the nitrite modalities, a* values were equivalent in processes A and B.

However, a* values with natural extracts were substantially more important in process B in comparison of process A.

This difference is surprising and showed a stabilization effect of the incorporation at an early stage of the process.

### 1.4 Color and Stability Study of Fresh Around Sausage

Dispersibility of all extracts was homogenous during process. Moreover, extracts adding did not influence initial meat pH and pH overtime (FIG. 10).

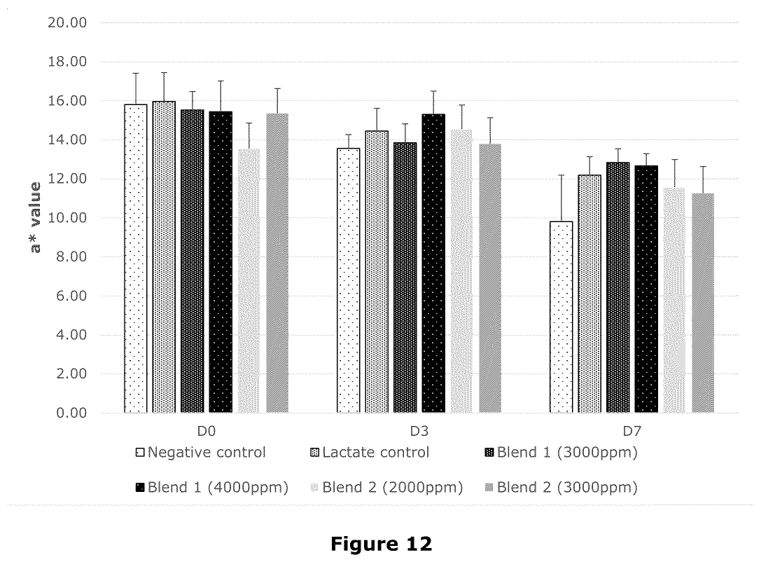

Fresh ground sausages showed a good red color preservation overtime, except for the control. This observation was confirmed by a* measurements in FIG. 12, there was no significant loss of red between the modalities, but a tendency for the negative control with lower a* values.

These results revealed that Natstabil M2 Blend 1 and Natstabil M2 Blend 2 were as effective as lactate/ascorbate to protect meat color during shelflife.

### 2.1 Microbiological Preservation of Cooked Emulsified Sausage

### 2.1.1. Spoilage

The microbiological analysis showed that the total flora and the lactic flora had a normal growth for the nitrite and the lactate modalities and for the natural extracts modalities, moreover, the ASR, the enterobacteria and the Pseudomonas were absent (<10 ufc/g). However, the control displayed the highest growth of total flora, enterobacteria and Pseudomonas.

The microbiological analysis showed equivalent results between control, nitrite and natural extracts.

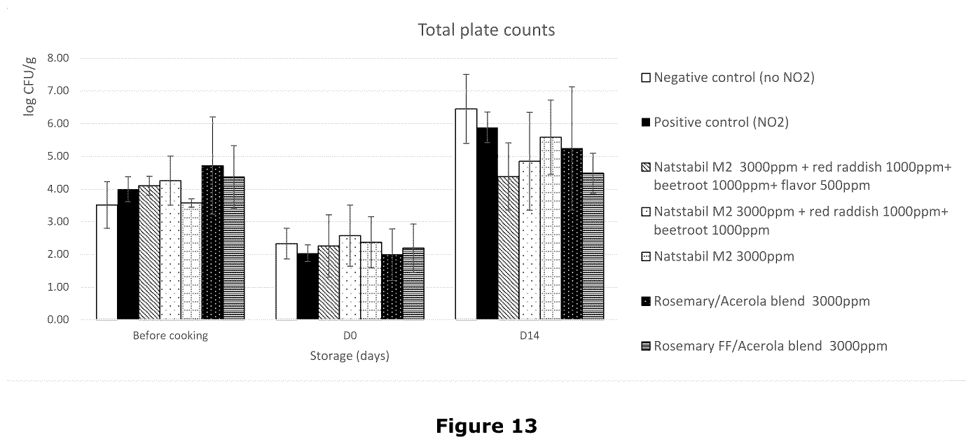

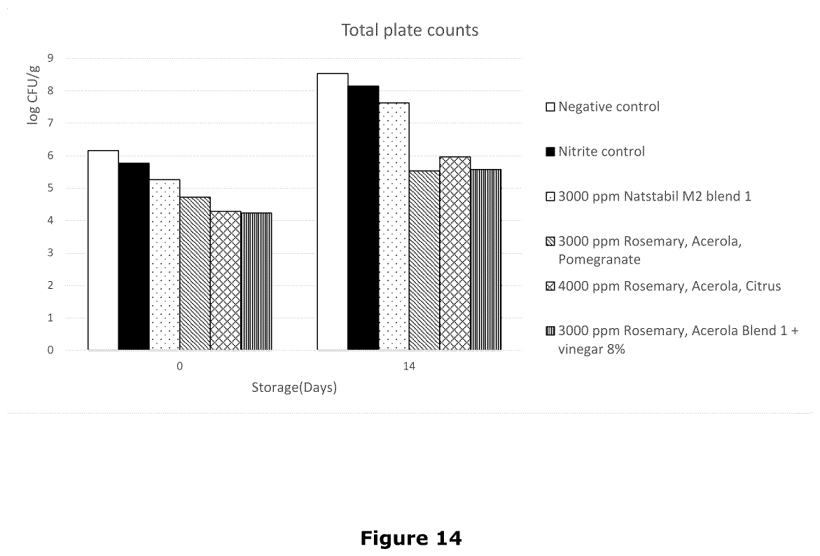

Main known group of bacteria found in meat product were targeted during the 14 days of storage. The total plate counts are shown in FIGS. 13 and 14. Normal growth is observed, with a diminution of the load after cooking step and then an increasing of total plate counts during the shelf life. After 14 days, emulsified sausages with blends have shown a lower level of contamination (total plate counts) than the negative control and positive control (with Nitrites).

It is remarkable that the blend with Natstabil M2 and red radish and beetroot have even a better antimicrobial effect than Natstabil M2 alone (see FIG. 13).

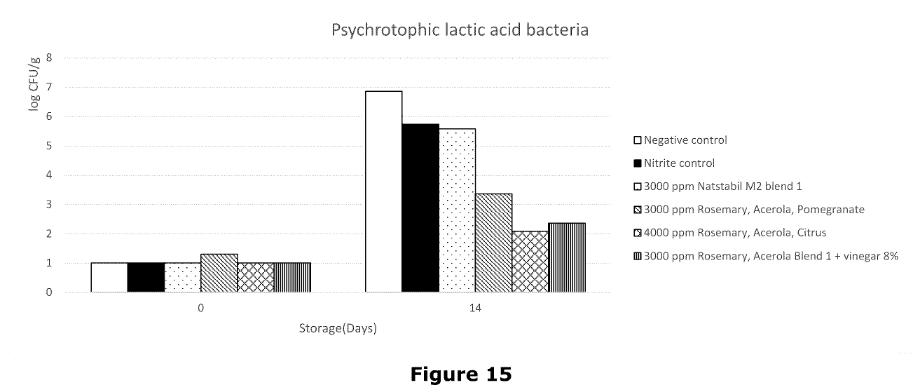

FIG. 15 shows similar results for psychrotophic lactic acid bacterias.

### 2.1.2. Pathogens

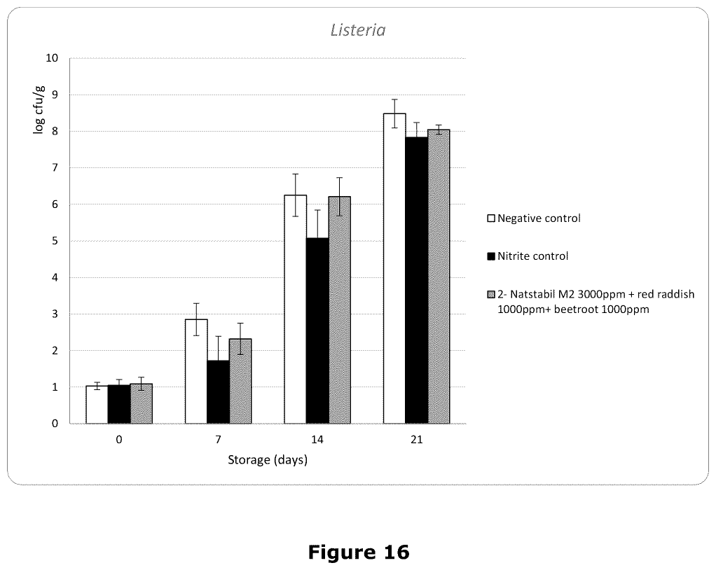

The challenge test with Listeria displayed a low growth under 4° C., but at 8° C. (day 14 & 21) the growth is important for all the modalities, this meat product is sensible and nitrite cannot limit the growth as the natural extracts (FIG. 16).

Statistically, negative control is significantly different to the others and natural extracts are equivalent to nitrite.

### 2.2 Microbiological Preservation of FRESH GROUND SAUSAGE

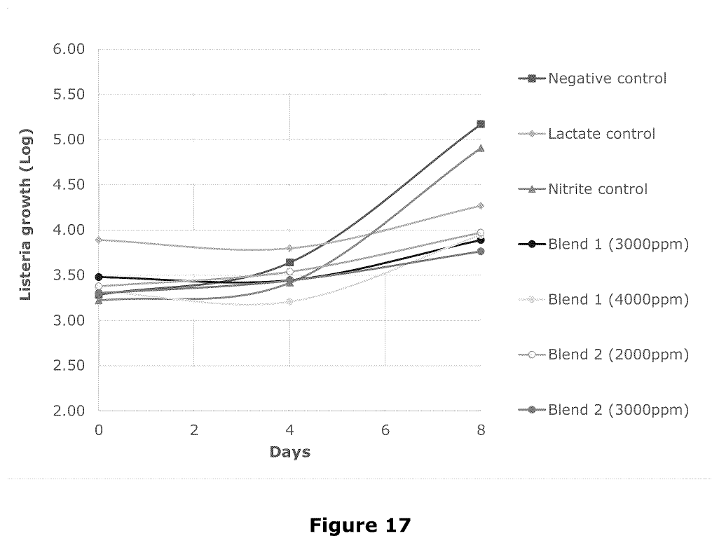

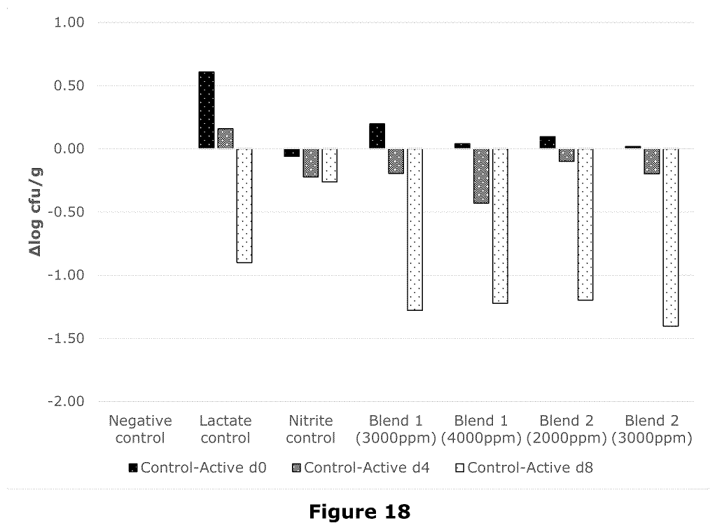

The challenge test with Listeria (FIG. 17 and FIG. 18) confirmed that nitrite has no action against Listeria in this application (Δ log cfu/g<−0.5 at d4 and d8), only lactate can limit its growth (Δ log cfu/g=−0.9 at d8).

Same limitation of Listeria growth was observed for Natstabil M2 Blend 1 and Natstabil M2 Blend 2 at the both dosages, with values not significantly different to lactate control (Δ log cfu/g>−1 at d8) (FIG. 17 and FIG. 18)

These results revealed that Natstabil M2 Blend 1 and Natstabil M2 Blend 2 were as effective as lactate to protect meat from Listeria.

Organoleptic studies were done. It was shown that the both blends are equivalents regarding the taste and the smell if compared with a standard reference. Thus the Blends 1 and Blend 2 do not modify the smell and taste of the final product (such as hot dogs or fresh sausages).

### CONCLUSION

Surprisingly, the mixture of red radish extract and beetroot juice is pink and stable after cooking and during storage, more stable than expected with calculations.

Purple sweet potato has a too purple shade to replace nitrite in this sausage application.

Red Radish and Red Radish in mixture with Beetroot could be alternatives to nitrite and even more stable based on the colour stability investigations undertaken.

1. A process for colouring a food product selected from meat, fish or meat analogue product having about 1% or more fat by weight of the food product and/or has a pH of about 4 or more, wherein the process comprises the addition of one or more anthocyanin(s) and/or one or more betanin(s) to the food product.

2. The process for colouring a food product according to claim 1, wherein the product is an emulsified product and the addition of one or more anthocyanin(s) and/or one or more betanin(s) to the food product is done before and/or during the emulsification process.

3. The process for colouring a food product according to claim 2, further comprising a step of heating the food product.

4. (canceled)

5. The process according to claim 1, wherein the anthocyanin is an anthocyanin glycoside.

6. The process according to claim 1, wherein the anthocyanin glycoside is acylated.

7. The process according to claim 1, wherein the anthocyanin comprises pelargonidin-type or a structural analogue thereof.

8. The process according to claim 1, wherein the anthocyanin is an extract obtained from a plant of the Brassicaceae family, the Rosacae family, the Solanaceae family or mixtures thereof.

9. The process according to claim 8, wherein the plant of the Brassicaceae family is Raphanus sativus L. (red radish), the plant of the Rosacae family is the Fragaria (strawberry), and/or the plant of the Solanaceae family is the Solanum tuberosum (red potato).

10. The process according to claim 1, wherein the betanin is an extract obtained from a plant of the Caryophyllales order.

11. The process according to claim 1, wherein the anthocyanin is an extract obtained from red radish and the betanin is present as an extract obtained from beetroot.

12. The process according to claim 1, wherein the product has 5% or more by weight of fat.

13. The process according to claim 1, wherein the anthocyanin and/or betanin is used in combination with an anti-oxidant and/or anti-microbial and optionally a flavorant.

14. The process according to claim 13, wherein the anti-oxidant and/or anti-microbial comprises a Lamiaceace extract, ascorbic acid, acetic acid hesperidin, punica extract (pomegranate) and combinations thereof.

15. The process according to claim 13, wherein the anti-oxidant and/or anti-microbial comprises a rosemary extract, acerola juice and acetic acid.

16. The process according to claim 1, wherein the food product is processed meat, processed fish or processed meat analogue.

17. The process according to claim 1, wherein the food product is an emulsified food product.

18. The process according to claim 1, wherein the food product has been subjected to a temperature of 40° C. or above for at least 10 minutes.

19. The process according to claim 1, wherein the food product has an L* from about 60 to about 80, a* from about 10 to about 18, and b* from about 5 to about 15.

20. (canceled)

21. A food product obtained by the process of claim 1.

22. (canceled)

23. The food product according to claim 21, wherein the product is substantially devoid of nitrites and/or ascorbate.

24. A food colouring composition comprising: (i) an anthocyanin extract obtained from a plant from the Brassicaceae family, the Rosacae family, the Solanaceae family and mixtures thereof, and/or (ii) a betalain extract obtained from a plant of the Amaranthaceae family, the Cactaceae family, and mixtures thereof.

25. (canceled)

26. (canceled)

27. The composition according to claim 24 further comprising an anti-oxidant and/or anti-microbial comprising a Lamiaceace extract, ascorbic acid, acetic acid, hesperidin, punica extract and combinations thereof.

28. The composition according to claim 27, wherein the anti-oxidant and/or anti-microbial comprises a rosemary extract, acerola juice and acetic acid.

29. (canceled)

30. (canceled)

31. (canceled)
